(19) United States
(12) Patent Application Publication
(10) Pub. No.: US 2025/0180598 A1
(43) Pub. Date: Jun. 5, 2025

(54) Physical Quantity Sensor And Inertial Measurement Unit

(71) Applicant: SEIKO EPSON CORPORATION, Tokyo (JP)

(72) Inventor: Satoru TANAKA, Chino (JP)

(21) Appl. No.: 18/961,809

(22) Filed: Nov. 27, 2024

(30) Foreign Application Priority Data
Nov. 30, 2023 (JP) 2023-203293

(51) Int. Cl. G01P 15/125; G01P 15/18

(52) U.S. Cl. CPC G01P 15/125; G01P 15/18

(57) ABSTRACT

A physical quantity sensor, which detects a physical quantity in a Z-axis direction along a Z-axis when three axes orthogonal to each other are set as an X-axis, a Y-axis, and the Z-axis, including: a fixing portion fixed to a substrate; an outer frame body coupled to the fixing portion; a support beam having one end coupled to the outer frame body and extending in an X-axis direction along the X-axis; a fixed electrode portion fixed to the substrate, and including a fixed electrode that extends in a Y-axis direction along the Y-axis; and a movable body including a movable electrode portion, coupled to another end of the support beam, and disposed inside the outer frame body, in which the movable electrode portion includes a movable electrode facing the fixed electrode in the X-axis direction, and the outer frame body includes a stopper portion facing the movable body along a plane direction including the X-axis and the Y-axis.

The present application is based on, and claims priority from JP Application Serial Number 2023-203293, filed Nov. 30, 2023, the disclosure of which is hereby incorporated by reference herein in its entirety.

### BACKGROUND

### 1. Technical Field

The present disclosure relates to a physical quantity sensor, an inertial measurement unit, and the like.

### 2. Related Art

A physical quantity sensor that swings a movable body like a seesaw to change a gap between a movable electrode portion included in the movable body and a fixed electrode portion, and detects a physical quantity such as an acceleration based on a change amount of an electrostatic capacitance is known. JP-A-2015-017886 discloses a method of providing a stopper, which restricts a movable range of a movable body, on a substrate.

Since the physical quantity sensor is configured by mounting various materials having different thermal expansion coefficients, warpage occurs in the substrate. Therefore, when the stopper is provided on the substrate, a positional relationship between the stopper and the movable body after actual mounting may be different from a design positional relationship, so that improvement in stability of a stopper function is required.

### SUMMARY

According to an aspect of the present disclosure, a physical quantity sensor, which detects a physical quantity in a third direction when three directions orthogonal to each other are set as a first direction, a second direction, and the third direction, includes: a fixing portion fixed to a substrate; an outer frame body coupled to the fixing portion; a support beam having one end coupled to the outer frame body and extending along the first direction; a movable body coupled to another end of the support beam, and disposed inside the outer frame body; and a fixed electrode portion provided on the substrate, disposed on the support beam in the second direction, and having a fixed electrode, in which the movable body has a movable electrode portion having a movable electrode that faces the fixed electrode, and the outer frame body has a stopper portion facing the movable body in an in-plane direction along the first direction and the second direction.

According to another aspect of the present disclosure, an inertial measurement unit includes: the physical quantity sensor described above; and a controller that performs control based on a detection signal output from the physical quantity sensor.

### BRIEF DESCRIPTION OF THE DRAWINGS

FIG. 1 is a plan view for explaining an example of a physical quantity sensor.

FIG. 2 is a plan view for explaining an example of a first detection unit.

FIG. 3 is a view for explaining an example of a relationship between an operation of a first movable electrode and a first fixed electrode.

FIG. 4 is a plan view for explaining an example of a second detection unit.

FIG. 5 is a view for explaining an example of a relationship between an operation of a second movable electrode and a second fixed electrode.

FIG. 6 is a sectional view for explaining an example of the physical quantity sensor.

FIG. 7 is a view for explaining an example of an operation mode of the physical quantity sensor.

FIG. 8 is a plan view for explaining another example of the physical quantity sensor.

FIG. 9 is a plan view for explaining another example of the physical quantity sensor.

FIG. 10 is a plan view for explaining another example of the physical quantity sensor.

FIG. 11 is a plan view for explaining another example of the physical quantity sensor.

FIG. 12 is a plan view for explaining another example of the physical quantity sensor.

FIG. 13 is a plan view for explaining another example of the physical quantity sensor.

FIG. 14 is a plan view for explaining another example of the physical quantity sensor.

FIG. 15 is a plan view for explaining another example of the physical quantity sensor.

FIG. 16 is a view for explaining another example of a relationship between the operation of the second movable electrode and the second fixed electrode.

FIG. 17 is an exploded perspective view illustrating a schematic configuration of an inertial measurement unit including the physical quantity sensor.

FIG. 18 is a perspective view of a circuit substrate of the physical quantity sensor.

### DESCRIPTION OF EMBODIMENTS

Hereinafter, preferred embodiments of the present disclosure will be described in detail. The present embodiment described below does not unreasonably limit contents described in the claims, and not all of the configurations described in the present embodiment are limited as essential constituent requirements.

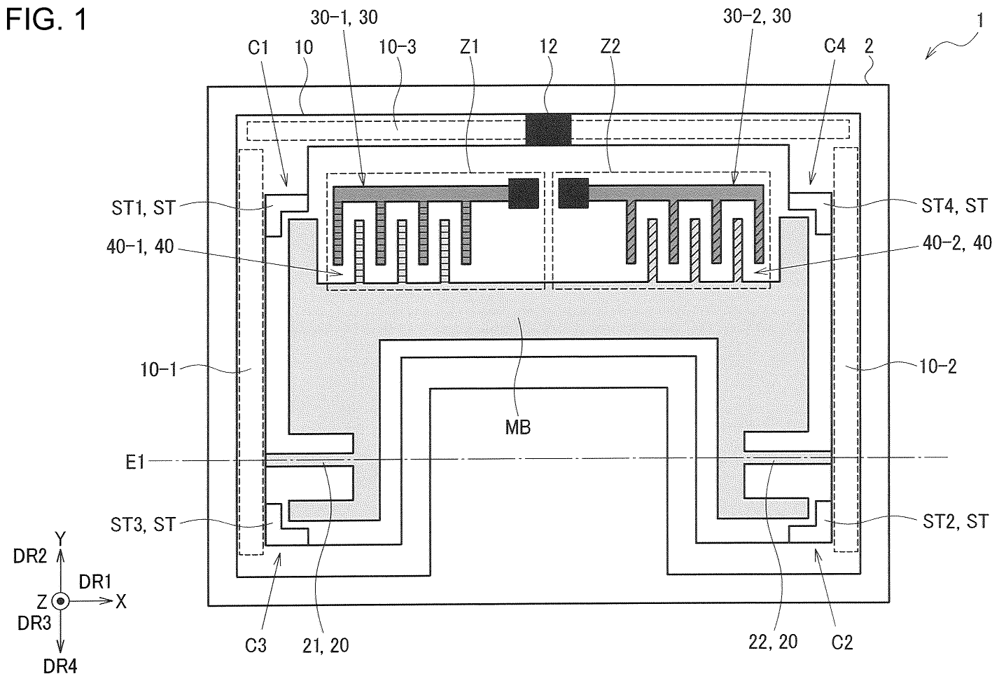

A configuration example of a physical quantity sensor 1 according to the present embodiment will be described with reference to FIGS. 1 to 6. The physical quantity sensor 1 of the present embodiment includes a substrate 2, an outer frame body 10 having a stopper portion ST, a fixing portion 12, a support beam 20, a fixed electrode portion 30, and a movable body MB having a movable electrode portion 40. FIG. 1 is a plan view of an example of the physical quantity sensor 1 of the present embodiment in a plan view from a direction orthogonal to the substrate 2. In addition, in FIG. 1, the directions orthogonal to each other are set as a first direction DR1, a second direction DR2, and a third direction DR3, in which the first direction DR1, the second direction DR2, and the third direction DR3 correspond to, for example, the +X-axis direction, the +Y-axis direction, and the +Z-axis direction, respectively. The physical quantity sensor 1 of the present embodiment is, for example, an inertial sensor as a micro electro mechanical systems (MEMS) device, and detects a physical quantity in the third direction DR3. The expression “orthogonal” includes a case where the first direction and the second direction intersect at an angle slightly inclined from 90° in addition to intersecting at 90°. In addition, according to the present embodiment, the direction opposite to the second direction DR2 is set as a fourth direction DR4. That is, the fourth direction DR4 in FIG. 1 is, for example, the −Y-axis direction. Further, the direction opposite to the third direction DR3 is set as a fifth direction DR5. For example, although not illustrated in FIG. 1, the fifth direction DR5 is, for example, the −Z-axis direction. Hereinafter, when it is not necessary to strictly distinguish the + direction and the − direction, the “direction along the X-axis” may be representatively expressed as the “direction along the first direction DR1”, the “direction along the Y-axis” may be representatively expressed as the “direction along the second direction DR2”, and the “direction along the Z-axis” may be representatively expressed as the “direction along the third direction DR3”.

For example, when an XY plane, which is a surface along the first direction DR1 and the second direction DR2, is set as a horizontal plane, the third direction DR3 is a vertical direction, and thus the physical quantity sensor 1 of the present embodiment can be applied as, for example, an acceleration sensor that detects an acceleration in the vertical direction. However, the correspondence relationship between the first direction DR1, the second direction DR2, and the third direction DR3 described above and the XYZ axes is merely an example, and is not limited to the above. The following description is not intended to prevent the present embodiment from being applied with, for example, the first direction DR1 or the second direction DR2 as the Z-axis, and it is not essential that any of the first direction DR1, the second direction DR2, and the third direction DR3 always be along the vertical direction.

Hereinafter, although a case where a physical quantity detected by the physical quantity sensor 1 is an acceleration is mainly described as an example, the physical quantity is not limited to the acceleration, and may be another physical quantity such as a velocity, a pressure, a displacement, a posture, an angular velocity, or gravity, and the physical quantity sensor 1 may be used as a pressure sensor or a MEMS switch. In addition, any of the drawings of the present embodiment schematically illustrate the dimensions of the members, the distances between the members, and the like for convenience of description, and do not indicate actual dimensions, distances, and the like. In addition, the physical quantity sensor 1 of the present embodiment is illustrated by appropriately omitting some of components such as electrodes and wirings.

The substrate 2 is, for example, a silicon substrate formed of semiconductor silicon or a glass substrate formed of a glass material such as borosilicate glass. However, the material of constituting the substrate 2 is not particularly limited, and a quartz substrate, a silicon on insulator (SOI) substrate, or the like may be used.

The fixing portion 12 is fixed to the substrate 2 and serves as an anchor of the movable body MB in a seesaw motion. The seesaw motion may also be referred to as a swinging motion. Specifically, the outer frame body 10 is coupled to the fixing portion 12, in which the outer frame body 10 is coupled to one end of the support beam 20, and the movable body MB is coupled to the other end of the support beam 20. As a result, an external force applied to the physical quantity sensor 1 induces the seesaw motion of the movable body MB via the substrate 2, the fixing portion 12, the outer frame body 10, and the support beam 20. Strictly, although the outer frame body 10 and the fixed electrode portion 30 can also vibrate or the like due to the external force applied to the physical quantity sensor 1, a structure of the outer frame body 10, the fixed electrode portion 30, the support beam 20, and the like is appropriately adjusted such that a degree of vibration or the like does not affect detection of the seesaw motion of the movable body MB.

In addition, according to the present embodiment, for example, the expression “the fixing portion 12 is fixed to the substrate 2” means that a member of the fixing portion 12 and a member of the substrate 2, which are originally separate, are fixed using a predetermined material and a predetermined method, but the present disclosure is not limited thereto. For example, for convenience of description, the expression includes a case where one member integrally formed is referred to as being divided into a part corresponding to the fixing portion 12 and a part corresponding to the substrate 2. Similarly, for example, the expression “the movable body MB is coupled to the other end of the support beam 20” includes a case where the support beam 20 is integrally formed as a part of the movable body MB, but the movable body MB and the support beam 20 are separated for convenience of description. In the following description, the same applies to the expressions “fixing”, “coupling”, “fix”, and “couple”.

The support beam 20 is provided such that the first direction DR1 is set as the longitudinal direction, and is bent in response to the seesaw motion of the movable body MB, in a plan view of FIG. 1. That is, the support beam 20 is twisted on the X-axis to provide a restoring force in the seesaw motion of the movable body MB. As described above, the support beam 20 has a property of a torsion spring that is twisted in the first direction DR1 serving as a rotation axis. As a result, the movable body MB realizes a swinging motion in the first direction DR1 serving as the rotation axis. In the example of FIG. 1, the movable body MB located on the second direction DR2 side with respect to the support beam 20 is configured to have a rotational torque that is larger than that of the movable body MB located on the fourth direction DR4 side with respect to the support beam 20.

The physical quantity sensor 1 of the present embodiment may include a single support beam 20 or a plurality of support beams 20. In FIG. 1, the first support beam 21 and the second support beam 22 that serve as the support beam 20 are illustrated as a more specific configuration example, but the physical quantity sensor 1 can be configured by omitting either one of the first support beam 21 and the second support beam 22.

The movable body MB includes the movable electrode portion 40. The movable electrode portion 40 has a movable electrode 46 facing the fixed electrode 36 of the fixed electrode portion 30. That is, the movable electrode portion 40 serves as a probe electrode that can move integrally with the movable body MB. The movable electrode portion 40 of the present embodiment is also used to mean the base portion of the movable electrode 46. Therefore, for example, it can be said that “the movable electrode 46 extends from the movable electrode portion 40”.

In the physical quantity sensor 1 of the present embodiment, the detection unit, which includes the fixed electrode portion 30 having the fixed electrode 36 and the movable electrode portion 40 having the movable electrode 46, detects a physical quantity such as an acceleration. A plurality of types of the detection units may be provided, and according to the present embodiment, the physical quantity sensor 1 including two types of detection units, that is, a first detection unit Z1 and a second detection unit Z2 is exemplified, but the type of the detection unit is not limited to two. Hereinafter, for convenience of description, the fixed electrode portion 30 included in the first detection unit Z1 may be distinguishably referred to as a first fixed electrode portion 30-1, and the fixed electrode portion 30 included in the second detection unit Z2 may be distinguishably referred to as a second fixed electrode portion 30-2. The same applies to the fixed electrode fixing portion 32, the fixed base portion 34, the fixed electrode 36, the movable electrode portion 40, and the movable electrode 46, which will be described later.

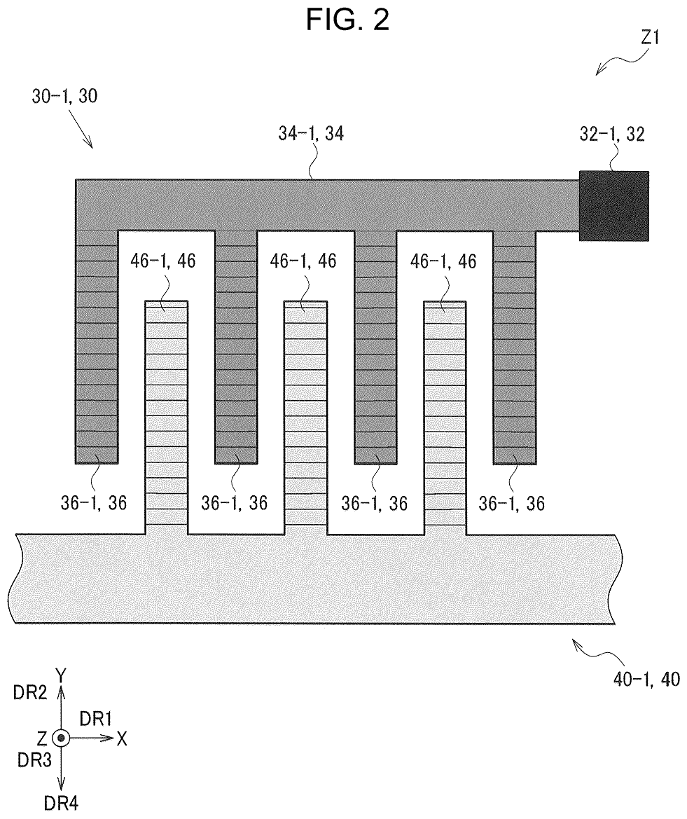

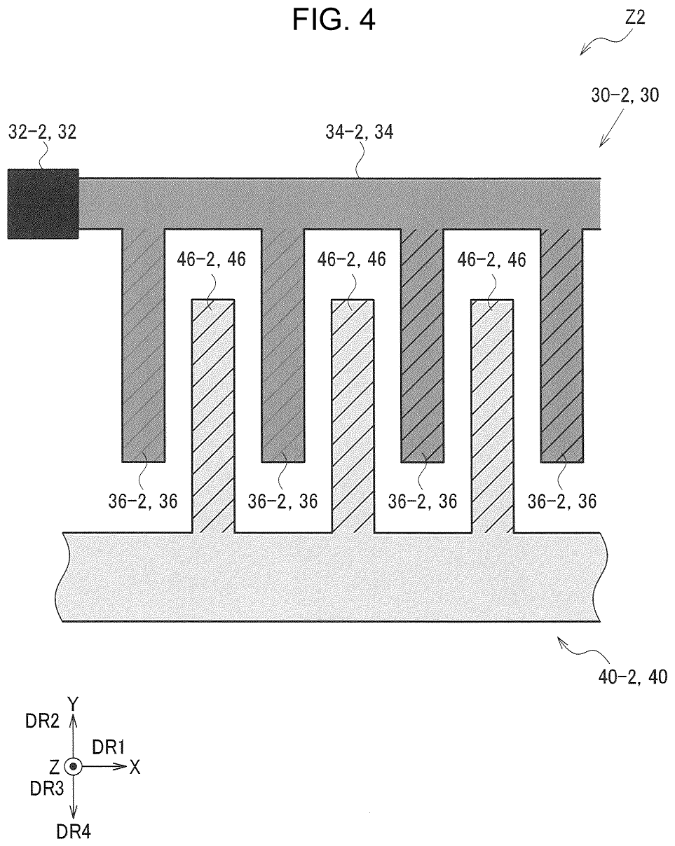

Further, in the examples of FIGS. 1 and 2, the first fixed electrode 36-1 of the first fixed electrode portion 30-1 and the first movable electrode 46-1 of the first movable electrode portion 40-1 have a predetermined thickness along the second direction DR2 and the third direction DR3. The thickness herein includes not only a physical thickness measured by a scanning electron microscope (SEM) or the like, but also a film thickness estimated based on optical characteristics such as a refractive index of a thin film. As a result, the first fixed electrode 36-1 and the first movable electrode 46-1 face each other with a predetermined area, and a predetermined physical quantity corresponding to the predetermined area can be detected. The predetermined physical quantity is, for example, electrostatic capacitance or the like. Thus, the first fixed electrode 36-1 and the first movable electrode 46-1 serve as, for example, electrodes on a P side of the probe. Similarly, in the examples of FIGS. 1 and 4, since the second fixed electrode 36-2 and the second movable electrode 46-2 also have a predetermined thickness along the second direction DR2 and the third direction DR3, a predetermined physical quantity corresponding to an area where the second fixed electrode 36-2 and the second movable electrode 46-2 face each other can be detected. As a result, the second fixed electrode 36-2 and the second movable electrode 46-2 serve as, for example, an electrode on an N side of the probe. At a predetermined timing, a sum of a predetermined physical quantity corresponding to the area where the first fixed electrode 36-1 and the first movable electrode 46-1 face each other and a predetermined physical quantity corresponding to the area where the second fixed electrode 36-2 and the second movable electrode 46-2 face each other is a predetermined physical quantity detected by the physical quantity sensor 1 at the predetermined timing.

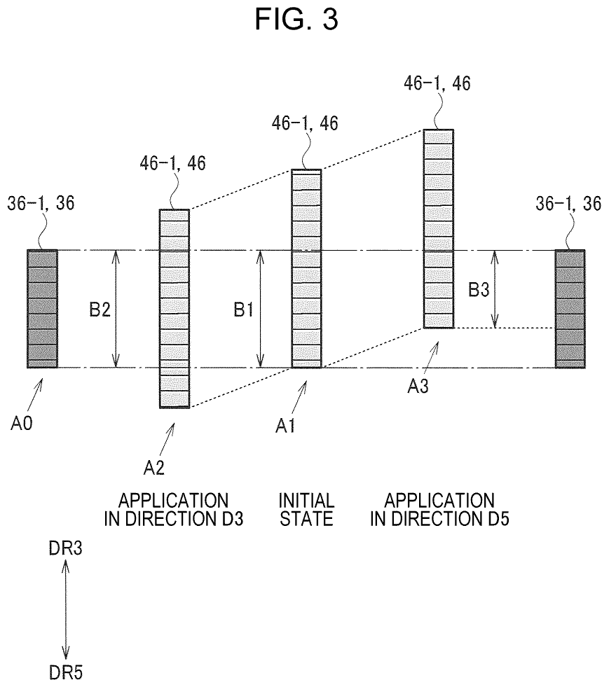

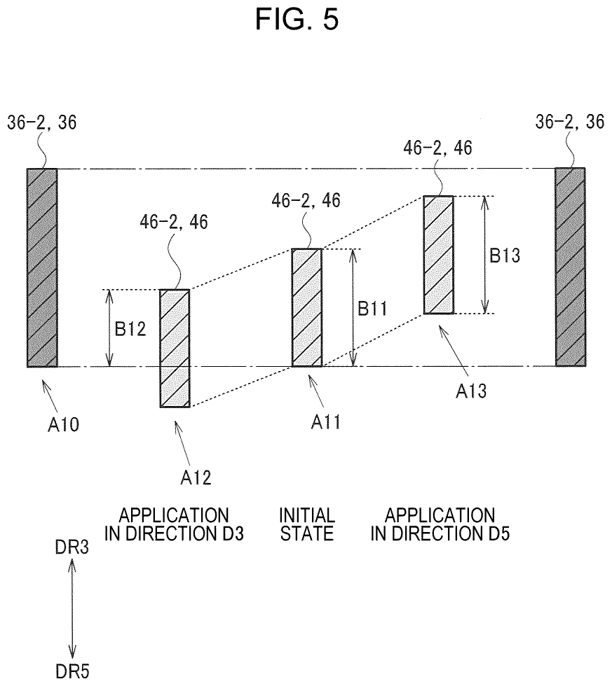

Examples of differences between the first detection unit Z1 and the second detection unit Z2 include that a relationship between the thicknesses of the first fixed electrode 36-1 and the first movable electrode 46-1 along the third direction DR3 in the first detection unit Z1 is different from a relationship between the thicknesses of the second fixed electrode 36-2 and the second movable electrode 46-2 along the third direction DR3 in the second detection unit Z2. In addition, for example, a relationship between the change in the area where the first fixed electrode 36-1 and the first movable electrode 46-1 face each other included in the first detection unit Z1 is different from a relationship between the change in the area where the second fixed electrode 36-2 and the second movable electrode 46-2 face each other included in the second detection unit Z2, and the details thereof will be described later with reference to FIGS. 3 and 5.

Hereinafter, the thickness of the first fixed electrode 36-1 along the third direction DR3 is simply referred to as the thickness of the first fixed electrode 36-1. The same applies to the first movable electrode 46-1, the second fixed electrode 36-2, and the second movable electrode 46-2. In addition, in order to facilitate visual understanding of the physical quantity sensor 1, a horizontal line is attached to the first fixed electrode 36-1 and the first movable electrode 46-1, and a diagonal line is attached to the second fixed electrode 36-2 and the second movable electrode 46-2.

FIG. 2 is a view for explaining the first detection unit Z1 in more detail. As illustrated in FIG. 2, the first fixed electrode portion 30-1 is fixed to the substrate 2 by the first fixed electrode fixing portion 32-1. The first fixed electrode portion 30-1 has the first fixed electrode 36-1. The first fixed electrode 36-1 extends along the Y-axis direction. One end of the first fixed base portion 34-1 is coupled to the first fixed electrode fixing portion 32-1, and the first fixed base portion 34-1 extends from the first fixed electrode fixing portion 32-1 along the first direction DR1. Thus, the first fixed electrode portion 30-1 serving as a tooth-shaped fixed electrode group can be stably configured.

In the first detection unit Z1 of FIGS. 1 and 2, the first fixed electrode 36-1 extends from the first fixed base portion 34-1 of the first fixed electrode portion 30-1 along the fourth direction DR4, and the first movable electrode 46-1 extends from the movable electrode portion 40 along the second direction DR2. However, the configuration example of the first detection unit Z1 is not limited thereto. For example, although not illustrated, the physical quantity sensor 1 can be configured such that the first fixed electrode 36-1 may extend from the first fixed base portion 34-1 along the second direction DR2 and the first movable electrode 46-1 may extend from the movable electrode portion 40 along the fourth direction DR4. The same applies to the second detection unit 22 to be described later with reference to FIG. 4. That is, in the physical quantity sensor 1 of the present embodiment, the fixed electrode 36 extends from the fixed base portion 34 along the second direction DR2, and the movable electrode 46 extends from the movable electrode portion 40 along the second direction DR2.

The first fixed electrode portion 30-1 is a toothed fixed electrode group in which a plurality of first fixed electrodes 36-1 are disposed in a tooth shape in a plan view in the third direction DR3, and the first movable electrode portion 40-1 is a toothed movable electrode group in which a plurality of first movable electrodes 46-1 are disposed in a tooth shape in a plan view in the third direction DR3. In the first detection unit Z1, each of the first fixed electrodes 36-1 of the toothed fixed electrode group of the first fixed electrode portion 30-1 and each of the first movable electrodes 46-1 of the toothed movable electrode group of the first movable electrode portion 40-1 are alternately disposed to face each other along the first direction DR1. As a result, a damping effect of a squeeze film in the first direction DR1, which is caused by the first fixed electrode 36-1 and the movable electrode 46-1, can be applied to the physical quantity sensor 1. Therefore, it is possible to improve vibration resistance and impact resistance of the physical quantity sensor 1. The same effect is also obtained for the second detection unit Z2 described later.

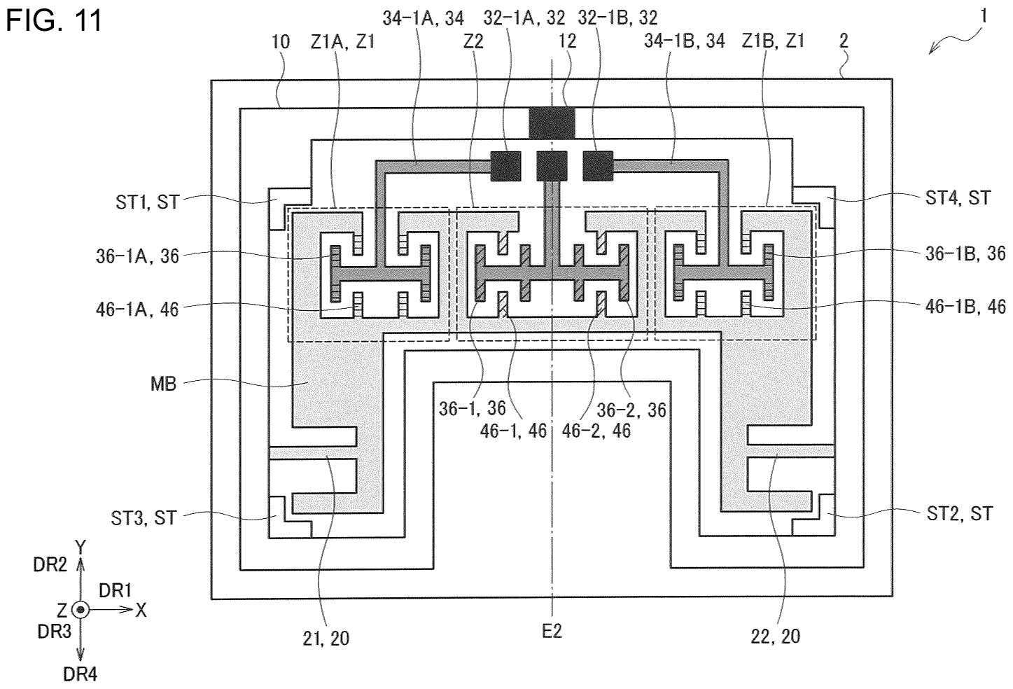

According to the present embodiment, the number of teeth of the fixed electrode 36 included in the detection unit and the number of teeth of the movable electrode 46 are not particularly limited as long as the numbers do not contradict the contents of the description. For example, in FIG. 2, the number of teeth of the first fixed electrode 36-1 and the first movable electrode 46-1 is illustrated as three, but the number of teeth of the first fixed electrode 36-1 and the first movable electrode 46-1 is not limited to three. For convenience of description, in all the drawings, a relationship between the teeth of the first fixed electrode 36-1 and the teeth of the first movable electrode 46-1 is not necessarily accurately illustrated, but the physical quantity sensor 1 of the present embodiment is configured such that the teeth of the first fixed electrode 36-1 are always disposed on both sides of the teeth of the first movable electrode 46-1 as illustrated in FIG. 2. Similarly, as illustrated in FIG. 4, the physical quantity sensor 1 of the present embodiment is configured such that the teeth of the second fixed electrode 36-2 are always disposed on both sides of the teeth of the second movable electrode 46-2. In addition, for example, in FIG. 11 described later, in addition to the relationship between the teeth disposition of the fixed electrode 36 and the movable electrode 46, the number of teeth of the fixed electrode 36 and the movable electrode 46 is not limited to the number illustrated in FIG. 11, and can be appropriately changed as long as the physical quantity sensor 1 is symmetrical with respect to a line E2.

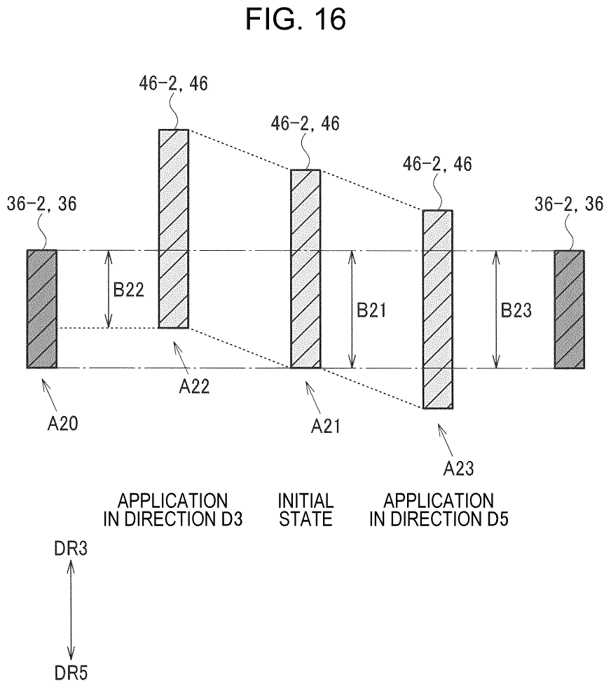

FIG. 3 is a view for explaining an example of a change in a positional relationship between the first fixed electrode 36-1 and the first movable electrode 46-1 in the third direction DR3 due to a seesaw operation of the movable body MB. In FIG. 3, the fifth direction DR5 side can also be referred to as a back side. The same applies to FIG. 5 and the like. For example, a timing in an initial state is referred to as a first timing, a timing in a state where the acceleration in the third direction DR3 is generated in the physical quantity sensor 1 is referred to as a second timing, and a timing in a state where the acceleration in the fifth direction DR5 is generated in the physical quantity sensor 1 is referred to as a third timing. The initial state herein refers to a stationary state where the acceleration is not generated except for the gravity acceleration. As indicated by A0 and A1 of FIG. 3, in the initial state, positions of end portions of the first fixed electrode 36-1 and the first movable electrode 46-1 in the fifth direction DR5 match each other. In addition, the thickness of the first movable electrode 46-1 in the third direction DR3 is larger than the thickness of the first fixed electrode 36-1 in the third direction DR3. Therefore, in the initial state, the position of the end portion of the first movable electrode 46-1 in the third direction DR3 is located on the third direction DR3 side with respect to the position of the end portion of the first fixed electrode 36-1 in the third direction DR3. The thicknesses of the first fixed electrode 36-1 and the first movable electrode 46-1 illustrated in FIG. 3 indicate only a relative relationship, and do not specify a specific size. The same applies to FIGS. 5 and 16 described later.

For example, when the first timing changes to the second timing, the first movable electrode 46-1 is displaced to a direction opposite to a direction of the acceleration generated in the physical quantity sensor 1, that is, to the fifth direction DR5 side, as indicated by A2 of FIG. 3, according to the above-described relationship of the rotational torque. Similarly, for example, when the first timing changes to the third timing, the first movable electrode 46-1 is displaced to the third direction DR3 side as indicated by A3 of FIG. 3. When B1 and B2 of FIG. 3 are compared with each other, in a case where the acceleration in the third direction DR3 is applied from the initial state, the area where the first fixed electrode 36-1 and the first movable electrode 46-1 face each other is maintained. On the other hand, when B1 and B3 of FIG. 3 are compared with each other, in a case where the acceleration in the fifth direction DR5 is applied from the initial state, the area where the first fixed electrode 36-1 and the first movable electrode 46-1 face each other is reduced. That is, when the acceleration in the fifth direction DR5 is generated, the first detection unit Z1 can detect a physical quantity in the fifth direction DR5 by detecting the change in the physical quantity due to the reduction in the area where the first fixed electrode 36-1 and the first movable electrode 46-1 face each other.

FIG. 4 is a view for explaining the second detection unit Z2 in more detail. As illustrated in FIG. 4, the second fixed electrode portion 30-2 is fixed to the substrate 2 by the second fixed electrode fixing portion 32-2. The second fixed electrode portion 30-2 has the second fixed electrode 36-2. The second fixed electrode 36-2 extends, for example, along the Y-axis direction. More specifically, for example, the second fixed electrode 36-2 extends from the second fixed base portion 34-2 of the second fixed electrode portion 30-2 along the fourth direction DR4. One end of the second fixed base portion 34-2 is coupled to the second fixed electrode fixing portion 32-2, and the second fixed base portion 34-2 extends from the second fixed electrode fixing portion 32-2 along the first direction DR1. In addition, the second fixed electrode portion 30-2 is a toothed fixed electrode group in which a plurality of second fixed electrodes 36-2 are disposed in a tooth shape in a plan view in the third direction DR3, and the second movable electrode portion 40-2 is a toothed movable electrode group in which a plurality of second movable electrodes 46-2 are disposed in a tooth shape in a plan view in the third direction DR3. In the second detection unit 22, each of the second fixed electrodes 36-2 of the toothed fixed electrode group of the second fixed electrode portion 30-2 and each of the second movable electrodes 46-2 of the toothed movable electrode group of the second movable electrode portion 40-2 are alternately disposed to face each other.

FIG. 5 is a view for explaining an example of a change in a positional relationship between the second fixed electrode 36-2 and the second movable electrode 46-2 in the third direction DR3 due to the seesaw operation of the movable body MB. As indicated by A10 and A11 of FIG. 5, in the initial state, positions of end portions of the second fixed electrode 36-2 and the second movable electrode 46-2 in the fifth direction DR5 match each other. In addition, a thickness of the second fixed electrode 36-2 in the third direction DR3 is larger than a thickness of the second movable electrode 46-2 in the third direction DR3. Therefore, the position of the end portion of the second fixed electrode 36-2 in the third direction DR3 is located on the third direction DR3 side with respect to the position of the end portion of the second movable electrode 46-2 in the third direction DR3.

For example, when the first timing changes to the second timing, the second movable electrode 46-2 is displaced to a direction opposite to a direction of the acceleration generated in the physical quantity sensor 1, that is, to the fifth direction DR5 side, as indicated by A12 of FIG. 5, according to the above-described relationship of the rotational torque. Similarly, for example, when the first timing changes to the third timing, the second movable electrode 46-2 is displaced to the third direction DR3 side as indicated by A13 of FIG. 5. When B11 and B12 of FIG. 5 are compared with each other, in a case where the acceleration in the third direction DR3 is applied from the initial state, an area where the second fixed electrode 36-2 and the second movable electrode 46-2 face each other is reduced. On the other hand, when B11 and B13 of FIG. 5 are compared with each other, in a case where the acceleration in the fifth direction DR5 is applied from the initial state, the area where the second fixed electrode 36-2 and the second movable electrode 46-2 face each other is maintained. That is, when the acceleration in the third direction DR3 is generated, the second detection unit Z2 can detect a physical quantity in the third direction DR3 by detecting the change in the physical quantity due to the reduction in the area where the second fixed electrode 36-2 and the second movable electrode 46-2 face each other. As described above, when the acceleration in the Z-axis direction is generated, the first detection unit Z1 and the second detection unit 22 have a relationship in which one electrostatic capacitance changes and the other electrostatic capacitance does not change in both the +Z direction and the −Z direction.

The outer frame body 10 is coupled to the fixing portion 12 described above and has a stopper portion ST. As will be described later, a plurality of stopper portions ST may be provided, and FIG. 1 illustrates a first stopper portion ST1, a second stopper portion ST2, a third stopper portion ST3, and a fourth stopper portion ST4, and for example, although the outer frame body 10 may be configured to have the first stopper portion ST1 and the second stopper portion ST2, for example, the outer frame body 10 may be configured to have only the first stopper portion ST1.

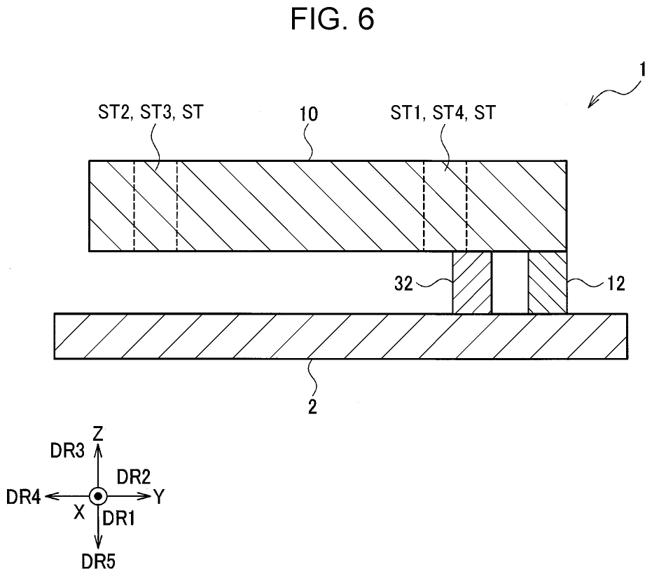

Further, the outer frame body 10 is coupled to one end of the coupled support beam 20. Specifically, for example, in FIG. 1, the outer frame body 10 is coupled to one end of the first support beam 21 and is also coupled to one end of the second support beam 22. For example, when the physical quantity sensor 1 is a MEMS sensor, the outer frame body 10 is integrally formed by the same manufacturing process as the movable body MB, the support beam 20, and the stopper portion ST. Therefore, as illustrated in FIG. 6, when the physical quantity sensor 1 of FIG. 1 is viewed in a sectional view in the first direction DR1 from the right side of FIG. 1, only the fixing portion 12 and the fixed electrode fixing portion 32 can be visually recognized between the substrate 2 and the outer frame body 10. In other words, in the physical quantity sensor 1 of the present embodiment, the fact that the stopper portion ST is disposed at a predetermined distance from the substrate 2 is different from the method in the related art.

Further, since the outer frame body 10 and the support beam 20 are integrally formed, it can be considered that FIG. 1 illustrates that the support beam 20 extends from the outer frame body 10 along the first direction DR1.

Since FIG. 6 is a view for explaining a relationship between the outer frame body 10, the stopper portion ST, and the substrate 2, other configurations are appropriately omitted and illustrated. In addition, although not visually recognized in FIG. 6, all of the end portion of the outer frame body 10 on the direction DR5 side, the end portion of the fixed electrode portion 30 on the direction DR5 side, the end portion of the movable electrode portion 40 on the direction DR5 side, and the end portion of the movable body MB on the direction DR5 side may be formed to be flush with each other. Thus, the manufacturing process of the physical quantity sensor 1 can be simplified.

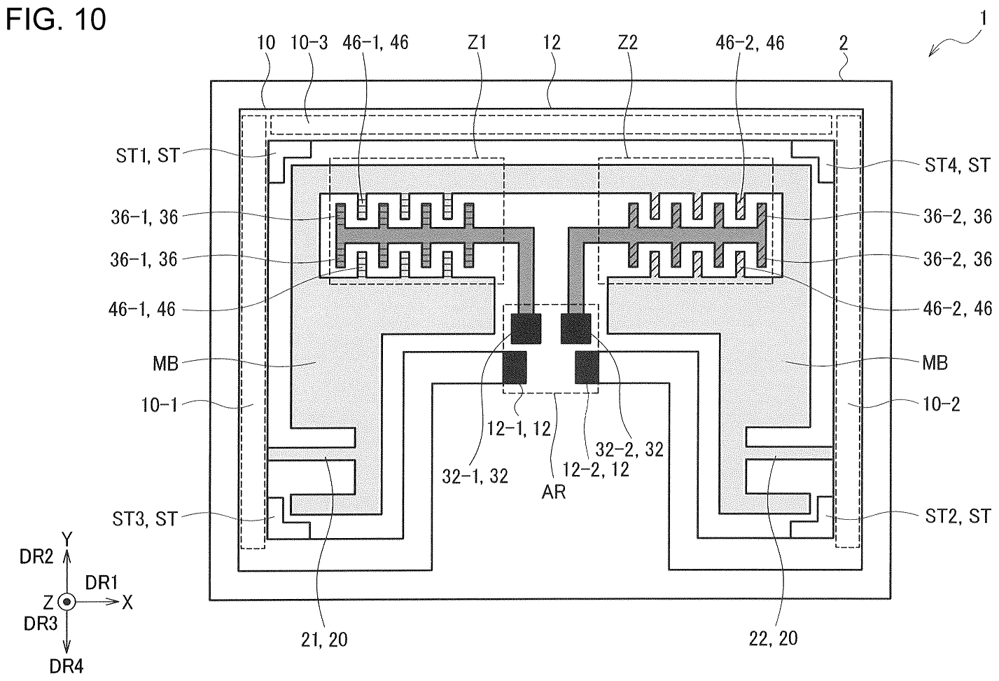

Further, the outer frame body 10 is configured to surround the movable body MB. In this case, surrounding the movable body MB means, for example, surrounding the entire periphery of the movable body MB and forming one closed loop in a plan view of FIG. 1. Thus, a degree of freedom in the disposition of the stopper portion ST can be increased. The outer frame body 10 of the present embodiment is not limited thereto, and as long as the stopper portion ST is stably operated, the outer frame body 10 may be configured such that a part thereof is opened in a plan view of FIG. 1, and details will be described later with reference to FIG. 10.

For example, as an example in which the outer frame body 10 surrounds the movable body MB and the outer frame body 10 is coupled to the movable body MB via the first support beam 21 and the second support beam 22 that serve as the support beam 20, a configuration example illustrated in FIG. 1 can be considered. Specifically, the outer frame body 10 includes a first part 10-1 along a first side and a second part 10-2 along a second side facing the first side. One end of the first support beam 21 is coupled to the first part 10-1 of the outer frame body 10, and the other end is coupled to the movable body MB. Further, one end of the second support beam 22 is coupled to the second part 10-2 of the outer frame body 10, and the other end is coupled to the movable body MB. Thus, the first support beam 21 and the second support beam 22 can be disposed along the rotation axis indicated by E1 of FIG. 1. As a result, the movable body MB can be coupled to the outer frame body 10, and the movable body MB can be stably operated as a seesaw.

Further, a specific position of the fixing portion 12 is not particularly limited, and may be determined, for example, in consideration of the symmetry of the outer frame body 10. Specifically, for example, the outer frame body 10 is configured to further include a third part 10-3 intersecting the first part 10-1 and the second part 10-2 in addition to the first part 10-1 and the second part 10-2 described above. That is, the outer frame body 10 including at least a U shape is configured by the first part 10-1, the second part 10-2, and the third part 10-3, and the fixing portion 12 is provided in the third part 10-3. Thus, since the fixing portion 12 is formed at a position close to the center of gravity of the outer frame body 10, the outer frame body 10 can be stably fixed to the substrate 2. The outer frame body 10 may be formed to further extend another part from the first part or the second part.

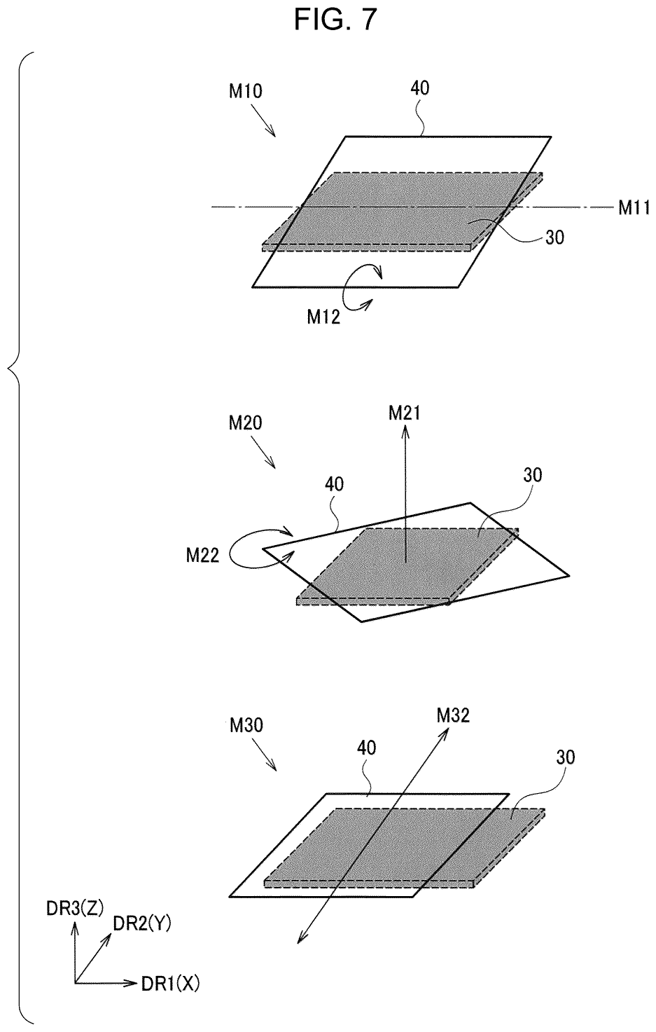

The stopper portion ST restricts an unnecessary operation mode from among operation modes of the physical quantity sensor 1. FIG. 7 conceptually illustrates examples of operation modes of the physical quantity sensor 1, in which examples of the operation modes of the physical quantity sensor 1 include the operation mode indicated by M10 of FIG. 7, the operation mode indicated by M20, the operation mode indicated by M30, and the like. The fixed electrode portion 30 and the movable electrode portion 40 illustrated in FIG. 7 are conceptually illustrated, and do not specify a specific structure or the like. The operation mode indicated by M10 is an operation mode corresponding to an operation in which the movable electrode portion 40 axially rotates about the rotation axis indicated by M11 with respect to the fixed electrode portion 30. The axis illustrated in M11 corresponds to the axis indicated by E1 of FIG. 1. The operation mode indicated by M20 is an operation mode corresponding to an operation in which the movable electrode portion 40 rotates about an axis indicated by M21 with respect to a plane including the fixed electrode portion 30, which can also be referred to as an in-plane rotation mode. The operation mode indicated by M30 is an operation mode corresponding to an operation in which the movable electrode portion 40 moves along a direction indicated by M32 with respect to a plane including the fixed electrode portion 30. The direction indicated by M32 is a direction along the Y-axis. When an acceleration having only a component in the X-axis direction is applied to the physical quantity sensor 1 of the present embodiment, the physical quantity sensor 1 is operated in the operation mode indicated by M20.

In the physical quantity sensor 1 of the present embodiment, the operation mode necessary for detecting the desired physical quantity is only the operation mode indicated by M10, and the operation mode indicated by M20 and the operation mode indicated by M30 are not necessary and need to be restricted. For example, the physical quantity sensor 1 has the stopper portion ST, so that when the operation mode indicated by M20 and the operation mode indicated by M30 occur, the positional relationship between the movable body MB and the stopper portion ST is designed such that the movable body MB abuts on the stopper portion ST before the fixed electrode 36 and the movable electrode 46 abut on each other.

Further, the position of the stopper portion ST is not particularly limited, but it is desirable to provide the first stopper portion ST1 at a first corner portion indicated by C1, for example. Since the outer frame body 10 is in a relationship of surrounding the movable body MB, it is convenient from a manufacturing point of view to provide the stopper portion ST at the corner portion of the outer frame body 10. In addition, when two stopper portions ST are provided, in addition to the first stopper portion ST1 described above, for example, a second stopper portion ST2 may be further provided at a second corner portion indicated by C2. In FIG. 1, the second corner portion is a corner portion at a diagonal position of the first corner portion, but may be at another position. In addition, three or more stopper portions ST may be provided. For example, a third stopper portion ST3 may be further provided in the third corner portion indicated by C3, and a fourth stopper portion ST4 may be further provided in the fourth corner portion indicated by C4. In FIG. 1, the third corner portion faces the first corner portion, and the fourth corner portion faces the second corner portion. Thus, the stopper portion ST can be more stably operated.

For example, in the physical quantity sensor 1 of the present embodiment, it is preferable to provide the first detection unit Z1 and the second detection unit Z2 at positions far from the rotation axis. As a result, the rotational torque can be efficiently generated. In other words, it is not necessary to provide the first detection unit Z1 and the second detection unit Z2 at a position close to the rotation axis, and a predetermined space may be configured. Therefore, an outer shape of the outer frame body 10 may be formed in, for example, a rectangular shape, but the outer frame body 10 may be formed in a recessed polygonal shape such that a predetermined space may be configured.

From the above description, the present embodiment is related to the physical quantity sensor 1 that detects the physical quantity in the third direction DR3 when three directions orthogonal to each other are set as the first direction DR1, the second direction DR2, and the third direction DR3. The physical quantity sensor 1 includes the fixing portion 12 fixed to the substrate 2, the outer frame body 10 coupled to the fixing portion 12, the support beam 20 having one end coupled to the outer frame body 10 and extending along the first direction DR1, the movable body MB coupled to the other end of the support beam 20 and disposed inside the outer frame body 10, and the fixed electrode portion 30 provided on the substrate 2, disposed in the second direction DR2 of the support beam 20, and having the fixed electrode 36. The movable body MB includes the movable electrode portion 40 having the movable electrode 46 facing the fixed electrode 36, and the outer frame body 10 has the stopper portion ST facing the movable body MB in an in-plane direction along the first direction DR1 and the second direction DR2.

As described above, since the physical quantity sensor 1 of the present embodiment includes the substrate 2, the movable body MB, the support beam 20, the fixed electrode portion 30, and the movable electrode portion 40, the physical quantity sensor 1 can function as a seesaw type physical quantity sensor 1 that detects the physical quantity in the third direction DR3. In addition, since the physical quantity sensor 1 of the present embodiment includes the stopper portion ST facing the movable body MB in the in-plane direction along the first direction DR1 and the second direction DR2, the displacement of the movable body MB in the first direction DR1 and the second direction DR2 can be restricted without inhibiting the inclination of the movable body MB in the third direction DR. In addition, the physical quantity sensor 1 of the present embodiment includes the outer frame body 10 fixed to the substrate 2 via the fixing portion 12, one end of the support beam 20 is coupled to the outer frame body 10, the other end of the support beam 20 is coupled to the movable body MB, and the movable body MB is disposed inside the outer frame body 10, so that the physical quantity sensor 1 in which the movable body MB is not directly fixed to the substrate 2 can be constructed.

As in the present embodiment, a method in which the outer frame body 10 includes the stopper portion ST is not proposed. That is, when the stopper portion ST is configured as the physical quantity sensor 1 provided on the substrate 2 by applying the method in the related art, warpage or the like occurs in the substrate 2 due to external stress, temperature change, or the like, but a method considering such a case is not proposed. More specifically, in the method in the related art, a possibility that the positional relationship between the stopper portion ST and the movable body MB changes due to warpage, strain, or the like of the substrate 2 is not considered. When the positional relationship between the stopper portion ST and the movable body MB changes, the fixed electrode portion and the movable electrode portion may abut on each other at a timing earlier than a timing at which the stopper portion ST and the movable body MB abut on each other by the operation of the movable body MB based on the in-plane rotation mode or the like, and the stopper portion ST is not operated. In this regard, by applying the method of the present embodiment, the movable body MB is integrated with the outer frame body 10 having the stopper portion ST without being directly fixed to the substrate 2. Therefore, even when warpage or the like occurs in the substrate 2, the positional relationship between the stopper portion ST and the movable body MB can be prevented from changing from the designed positional relationship. As a result, the stopper portion ST can be stably operated. As a result, the physical quantity sensor 1 having excellent impact resistance and high reliability can be constructed.

Further, in the physical quantity sensor 1 of the present embodiment, the outer frame body 10 may include the first stopper portion ST1 provided at the first corner portion of the outer frame body 10, and the second stopper portion ST2 provided at the second corner portion of the outer frame body 10, as the stopper portion ST. Thus, the stopper portion ST can be more stably operated.

As described above, in the physical quantity sensor 1 of the present embodiment, the outer frame body 10 may include the third stopper portion ST3 provided at the third corner portion of the outer frame body 10 facing the first corner portion, and the fourth stopper portion ST4 provided at the fourth corner portion of the outer frame body 10 facing the second corner portion, as the stopper portion ST. Thus, the stopper portion ST can be more stably operated.

In the physical quantity sensor 1 of the present embodiment, the outer frame body 10 may surround the entire periphery of the movable body MB. Thus, a degree of freedom in the disposition of the stopper portion ST can be increased.

Further, in the physical quantity sensor 1 of the present embodiment, the fixed electrode portion 30 may include the fixed base portion 34, the fixed electrode 36 extending from the fixed base portion 34, and the fixed electrode fixing portion 32 fixing the fixed base portion 34 to the substrate 2. Thus, the tooth-shaped fixed electrode group can be stably configured.

Further, in the physical quantity sensor 1 of the present embodiment, the fixed electrode 36 may extend from the fixed base portion 34 in the second direction DR2, and the movable electrode 46 may extend from the movable electrode portion 40 along the second direction DR2. Thus, a detection unit, in which a fixed toothed electrode group of the fixed electrode 36 and a movable toothed electrode group of the movable electrode 46 are alternately disposed along the first direction DR1, can be constructed. As a result, the damping effect of the squeeze film in the first direction DR1, which is caused by the fixed electrode 36 and the movable electrode 46, can be applied to the physical quantity sensor 1. Therefore, it is possible to improve vibration resistance and impact resistance of the physical quantity sensor 1.

Further, in the physical quantity sensor 1 of the present embodiment, the fixed electrode portion 30 may include the first fixed electrode portion 30-1 having the first fixed electrode 36-1 and the second fixed electrode portion 30-2 having the second fixed electrode 36-2. In addition, the movable body MB may include the first movable electrode portion 40-1 having the first movable electrode 46-1 facing the first fixed electrode 36-1, and the second movable electrode portion 40-2 having the second movable electrode 46-2 facing the second fixed electrode 36-2. In addition, the first fixed electrode portion 30-1 and the first movable electrode portion 40-1, and the second fixed electrode portion 30-2 and the second movable electrode portion 40-2 may be disposed along the first direction DR1. Thus, it is possible to construct the physical quantity sensor 1 having a one-sided seesaw structure which includes the first detection unit Z1 including the first fixed electrode portion 30-1 and the first movable electrode portion 40-1, and the second detection unit Z2 including the second fixed electrode portion 30-2 and the second movable electrode portion 40-2.

Further, in the physical quantity sensor 1 of the present embodiment, the thickness of the first movable electrode 46-1 in the third direction DR3 may be larger than the thickness of the first fixed electrode 36-1 in the third direction DR3. In addition, the thickness of the second movable electrode 46-2 in the third direction DR3 may be smaller than the thickness of the second fixed electrode 36-2 in the third direction DR3. Thus, the physical quantity applied in the third direction DR3 can be detected by the second detection unit Z2 including the second fixed electrode portion 30-2 and the second movable electrode portion 40-2, and the physical quantity applied in the fifth direction opposite to the third direction DR3 can be detected by the first detection unit Z1 including the first fixed electrode portion 30-1 and the first movable electrode portion 40-1.

As described above, in the physical quantity sensor 1 of the present embodiment, the outer frame body 10 may include the first part 10-1 along the first side and the second part 10-2 along the second side facing the first side. In addition, the support beam 20 may include the first support beam 21 having one end coupled to the first part 10-1 of the outer frame body 10 and the other end coupled to the movable body MB, and the second support beam 22 having one end coupled to the second part 10-2 of the outer frame body 10 and the other end coupled to the movable body MB. Thus, the movable body MB coupled to the outer frame body 10 can be more stably operated.

As described above, in the physical quantity sensor 1 of the present embodiment, the outer frame body 10 may include the first part 10-1 along the first side, the second part 10-2 along the second side facing the first side, and the third part 10-3 intersecting the first part 10-1 and the second part 10-2, and the fixing portion 12 may be provided at the third part 10-3. Thus, the outer frame body 10 can be stably fixed to the substrate 2.

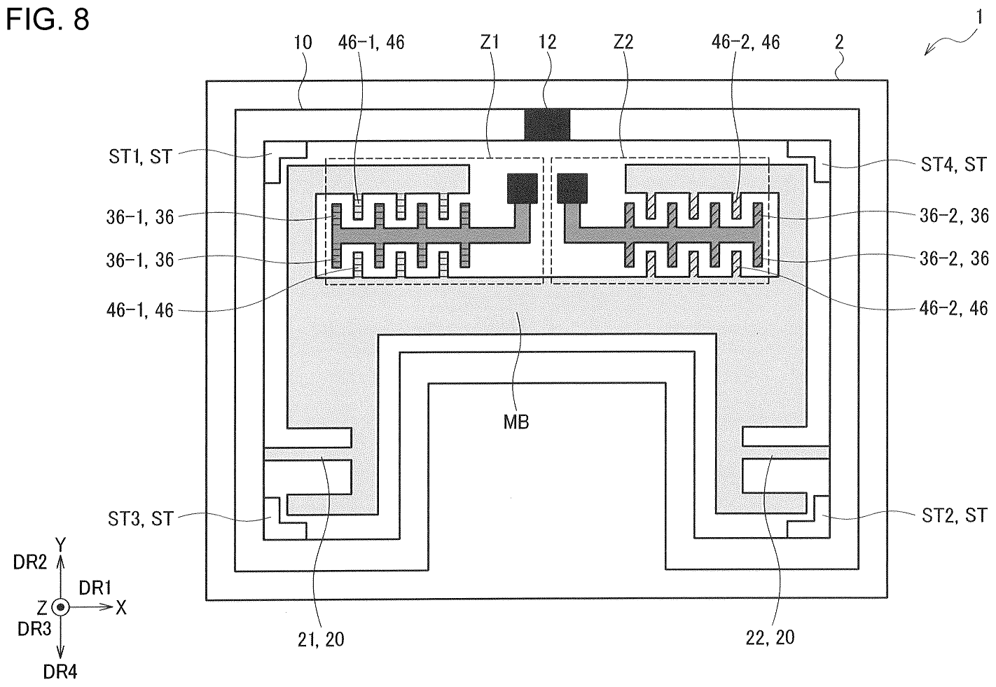

The method of the present embodiment is not limited to the above, and various modifications can be performed. For example, the physical quantity sensor 1 of the present embodiment may be configured as in the configuration example illustrated in FIG. 8. Hereinafter, the description, reference numerals, and the like of the known configurations and the like are appropriately omitted. The first detection unit Z1 of FIG. 1 is configured such that the first fixed electrode 36-1 extends from one side of the first fixed base portion 34-1, whereas the first detection unit Z1 of FIG. 8 is configured such that the first fixed electrode 36-1 extends from both sides of the first fixed base portion 34-1. In other words, in FIG. 8, the first detection unit Z1 is configured such that two sets of the first fixed electrode 36-1 and the first movable electrode 46-1 are present along the Y-axis. As a result, when an area occupied by the first detection unit Z1 is the same in a plan view in the Z direction, in the configuration example of FIG. 8, the first fixed electrode 36-1 and the first movable electrode 46-1 are configured to be shorter than those in the configuration example of FIG. 1. In this case, the expression “same” includes “substantially the same”. In addition, the second detection unit Z2 is the same as the first detection unit Z1, and in the configuration example of FIG. 8, the second fixed electrode 36-2 and the second movable electrode 46-2 are configured to be shorter than those in the configuration example of FIG. 1. In addition, the first fixed base portion 34-1 and the second fixed base portion 34-2 extend toward the fixing portion 12 such that the first fixed electrode fixing portion 32-1 and the second fixed electrode fixing portion 32-2 that serve as the fixed electrode fixing portion 32 are disposed adjacent to the fixing portion 12.

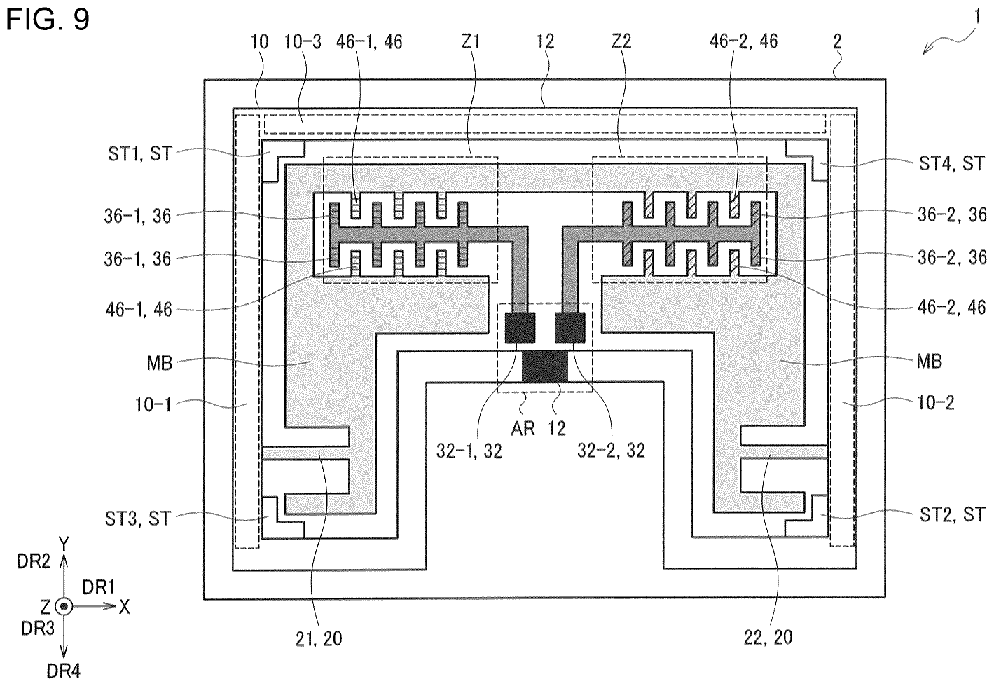

By configuring as in the configuration example of FIG. 8, an aspect ratio of each of the fixed electrodes 36 and the movable electrodes 46 can be reduced. As a result, rigidity of the fixed electrode 36 and the movable electrode 46 can be enhanced. Accordingly, the impact resistance of the physical quantity sensor 1 can be further enhanced. In the examples illustrated in FIG. 9 and the subsequent drawings described later, the example including the method of FIG. 8 is illustrated, but the method of FIG. 8 is not essential, and the adoption of the method of FIG. 8 may be appropriately determined.

The detection unit may be configured such that three or more combinations of the fixed electrode 36 and the movable electrode 46 are present along the Y-axis. Specifically, for example, although not illustrated, a plurality of fixed base portions 34 may be disposed along the X-axis, the fixed electrode 36 may be extended along the Y-axis from one side or both sides of each fixed base portion 34, and the movable body MB and the movable electrode 46 may be configured to face the extended fixed electrodes 36.

Further, the physical quantity sensor 1 of the present embodiment may have a configuration example as illustrated in FIG. 9. The configuration example of FIG. 9 is different from the configuration example of FIG. 8 in that the fixing portion 12 and the first fixed electrode fixing portion 32-1 and the second fixed electrode fixing portion 32-2 that serve as the fixed electrode fixing portion 32 are concentratedly disposed in a predetermined region within a predetermined range from a central position of the substrate 2. According to the present embodiment, the predetermined region is referred to as a fixing portion disposition region AR. That is, in the physical quantity sensor 1 of the present embodiment, the fixing portion 12 and the first fixed electrode fixing portion 32-1 and the second fixed electrode fixing portion 32-2 that serve as the fixed electrode fixing portion 32 are disposed in the fixing portion disposition region AR. Thus, the influence of warpage of the substrate 2 on the fixing portion 12 and the fixed electrode fixing portion 32 can be reduced.

Specifically, the influence caused by the warpage of the substrate 2 on various devices disposed on the substrate 2 becomes greater as a distance from the center of the substrate 2 increases. In this regard, by applying the method of the present embodiment, the fixing portion 12 and the fixed electrode fixing portion 32 can be disposed in the fixing portion disposition region AR located in the vicinity of the center of the substrate. As a result, for example, when the warpage occurs in the substrate 2 due to an external stress or a temperature change, it is possible to suppress fluctuation of an electric signal output from a probe electrode including the fixed electrode fixing portion 32. In this case, although not illustrated, it is preferable that the center of the substrate 2 is located in the fixing portion disposition region AR.

Further, the difference is that the fixing portion 12 is provided at the third part 10-3 in the configuration examples of FIGS. 1 and 8, whereas the fixing portion 12 is disposed in the fixing portion disposition region AR in the configuration example of FIG. 9. As described above, since the outer frame body 10 has a U shape by the first part 10-1, the second part 10-2, and the third part 10-3, it is considered that the fixing portion disposition region AR is located in a region surrounded by the first part 10-1, the second part 10-2, and the third part 10-3. That is, in the physical quantity sensor of the present embodiment, the outer frame body 10 includes the first part 10-1 along the first side, the second part 10-2 along the second side facing the first side, and the third part 10-3 intersecting the first part 10-1 and the second part 10-2. The fixing portion 12 is disposed in a region surrounded by the first part 10-1, the second part 10-2, and the third part 10-3. Thus, a maximum distance from the fixing portion 12 to the end portion of the outer frame body 10 can be shortened. Since the outer frame body 10 can be treated as a cantilever beam having the fixing portion 12 serving as a fixed end, there is a possibility that a part of the outer frame body 10 far from the fixing portion 12 may be bent. In this regard, by applying the method of the present embodiment, the fixing portion 12 can be located in the vicinity of the center of the outer frame body 10 in a plan view from the Z-axis direction. As a result, the occurrence of bending of the outer frame body 10 can be suppressed, and thus a high-precision physical quantity sensor 1 can be constructed. In addition, the first fixed base portion 34-1 and the second fixed base portion 34-2 extend toward the fixing portion 12 such that the first fixed electrode fixing portion 32-1 and the second fixed electrode fixing portion 32-2 that serve as the fixed electrode fixing portion 32 are disposed adjacent to the fixing portion 12.

Further, FIGS. 1, 8, and 9 illustrate the configuration example in which the outer frame body 10 is fixed to the substrate 2 by a single fixing portion 12, but for example, a plurality of fixing portions 12 may be provided. In addition, in FIGS. 1, 8, and 9, the outer frame body 10 is illustrated as forming a closed loop, but a part thereof may be opened. Specifically, for example, the physical quantity sensor 1 of the present embodiment may be configured as the configuration example illustrated in FIG. 10. In the example of FIG. 10, as compared with FIG. 9, the outer frame body 10 is opened, and fixing portion 12-1 and the fixing portion 12-2 that serve as fixing portions 12 are provided at both ends of the outer frame body 10. In addition, as illustrated in FIG. 10, the fixing portion 12-1 and the fixing portion 12-2 may be disposed in the fixing portion disposition region AR. As described above, in the physical quantity sensor 1 of the present embodiment, the outer frame body 10 is opened in at least a part of the region around the movable body MB. Thus, the physical quantity sensor 1 that stably operates the stopper portion ST can be constructed while improving the degree of freedom in design. For example, although not illustrated, since wiring from the fixed electrode 36 can pass through the opened region and be drawn out to an outside of the movable body MB, in the configuration example illustrated in FIG. 10, the degree of freedom in design is improved as compared with the configuration example illustrated in FIG. 9. It may be appropriately determined whether the outer frame body 10 is configured to surround the entire periphery of the movable body MB as illustrated in FIG. 1 or the outer frame body 10 is configured to open a part thereof as illustrated in FIG. 10.

Further, the physical quantity sensor 1 of the present embodiment may have a configuration example as illustrated in FIG. 11. In FIG. 11, the second detection unit Z2 is disposed at the center of the substrate 2 in the X-axis direction. In addition, the first detection unit Z1 is divided into a first detection unit A (Z1A) and a first detection unit B (Z1B), in which the first detection unit A (Z1A) and the first detection unit B (Z1B) are disposed on both sides of the second detection unit Z2, respectively, in the X-axis direction. In addition, a structure of the first detection unit A (Z1A) including a first fixed electrode 36-1A and a first movable electrode 46-1A and a structure of the first detection unit B (Z1B) including a first fixed electrode 36-1B and a first movable electrode 46-1B are symmetrical with respect to the line indicated by E2. In addition, the structure of the second detection unit Z2 including the second fixed electrode 36-2 and the second movable electrode 46-2 is symmetrical with respect to the line indicated by E2. That is, the entire structure of the physical quantity sensor 1 is symmetrical with respect to the line indicated by E2, and the center of gravity of the physical quantity sensor 1 is present at a position on the line indicated by E2.

In the configuration examples illustrated in FIGS. 1, 8, 9, and 10, thicknesses of the first fixed electrode 36-1 and the first movable electrode 46-1 constituting the first detection unit Z1 are different from thicknesses of the second fixed electrode 36-2 and the second movable electrode 46-2 constituting the second detection unit Z2, and thus, the weight of the entire first detection unit Z1 is different from a weight of the entire first detection unit Z1. Therefore, the center of gravity position of the physical quantity sensor 1 in the X-axis direction is shifted. In this regard, in the configuration example illustrated in FIG. 11, a weight balance is improved as compared with the configuration examples illustrated in FIGS. 1, 8, 9, and 10, and thus the high-precision physical quantity sensor 1 can be constructed while stably operating the stopper portion ST.

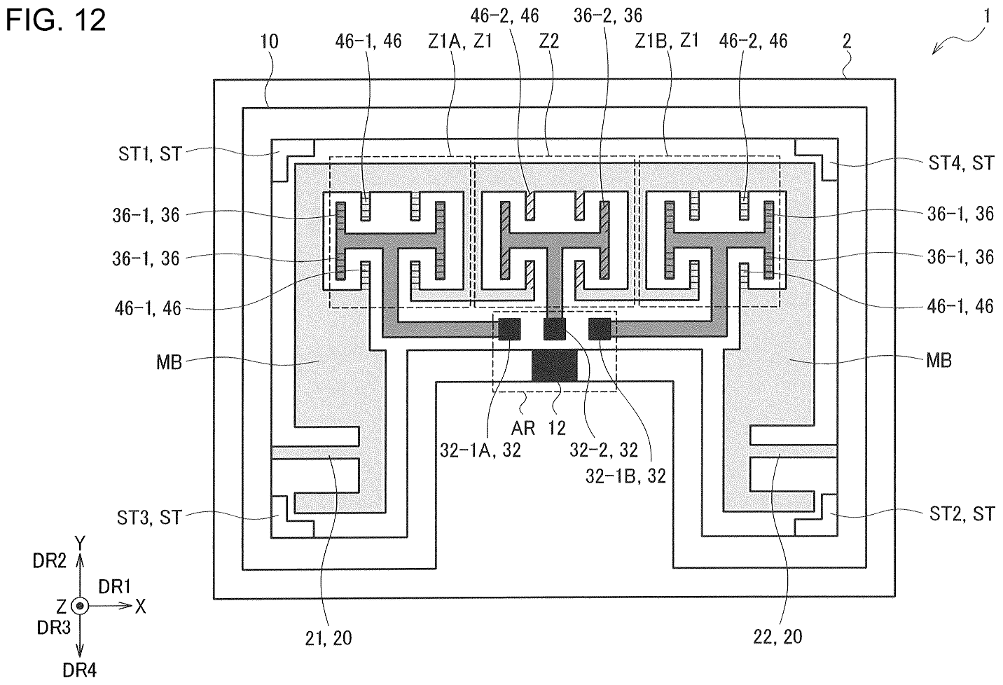

In addition, the method described with reference to FIG. 11 and the method described with reference to FIG. 9 may be combined, and specifically, for example, the physical quantity sensor 1 of the present embodiment may have the configuration example illustrated in FIG. 12. FIG. 12 is different from FIG. 11 in that the fixing portion 12, the first fixed electrode fixing portion 32-1A included in the first detection unit A (Z1A), the first fixed electrode fixing portion 32-1B included in the first detection unit B (Z1B), and the second fixed electrode fixing portion 32-2 are disposed in the fixing portion disposition region AR. Thus, in addition to the effect described above in FIG. 11, it is possible to reduce the influence of the warpage of the substrate on the fixing portion 12, the first fixed electrode fixing portion 32-1A, the first fixed electrode fixing portion 32-1B, and the second fixed electrode fixing portion 32-2.

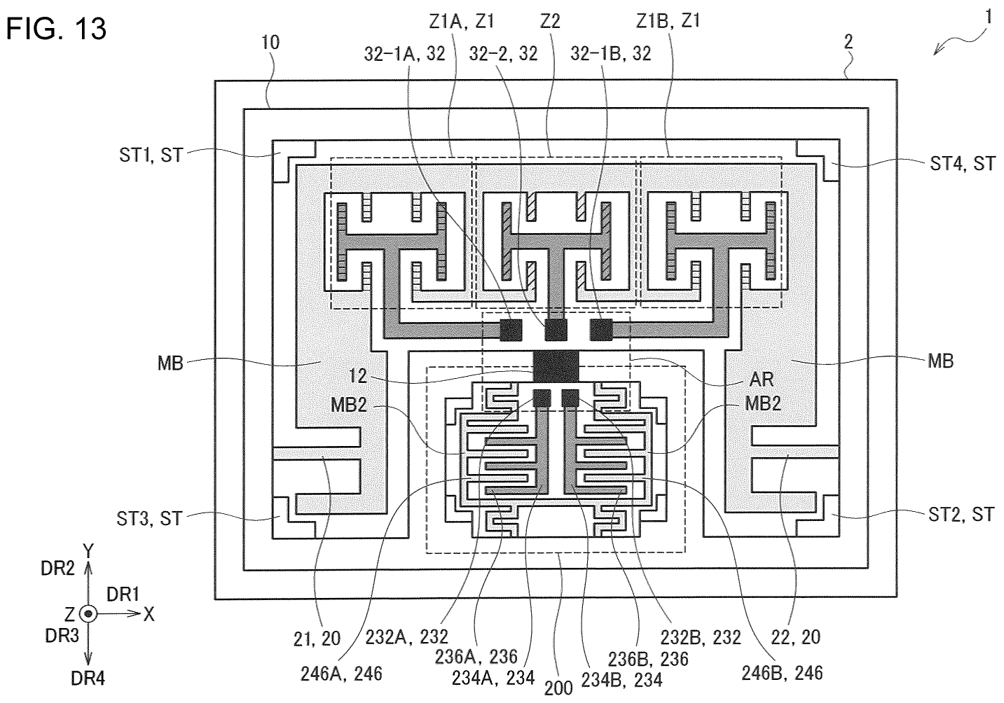

Further, the physical quantity sensor 1 of the present embodiment may have a configuration example as illustrated in FIG. 13. The example of FIG. 13 is different from the configuration example of FIG. 12 in that a second physical quantity sensor portion 200 is provided in the predetermined space described above in FIG. 1. When the physical quantity sensor 1 is a sensor that detects the physical quantity in the Z-axis direction, the second physical quantity sensor portion 200 may be a sensor that detects a physical quantity in the X-axis direction or the Y-axis direction, a sensor having an integrated structure, which detects a physical quantity in the two-axis direction, or the like. Alternatively, the second physical quantity sensor portion 200 may be a sensor having a different detection target such as a pressure sensor. That is, the physical quantity sensor 1 of the present embodiment includes the second physical quantity sensor portion 200 provided between the first support beam 21 and the second support beam 22 and detecting a second physical quantity. Thus, an area of the substrate 2 can be effectively utilized. As a result, a size of a unit including the physical quantity sensor 1 can be reduced.

For example, when the second physical quantity sensor portion 200 is a sensor that detects a physical quantity in the Y-axis direction, the second physical quantity sensor portion 200 includes a second sensor movable body MB2, similar to the physical quantity sensor 1. In this case, the second sensor movable body MB2 may be coupled to the outer frame body 10. For example, when the physical quantity sensor 1 is a MEMS sensor, the second sensor movable body MB2 can be coupled to the outer frame body 10 by integrally forming the outer frame body 10 and the second sensor movable body MB. That is, in the physical quantity sensor 1 of the present embodiment, the second physical quantity sensor portion 200 includes the second sensor movable body MB2 coupled to the outer frame body 10. Thus, the outer frame body 10 integrated with the second sensor movable body MB2 can be configured, thereby simplifying the manufacturing process.

Further, similar to the physical quantity sensor 1, the second physical quantity sensor portion 200 may be a combination of a toothed fixed electrode group in which a second sensor fixed electrode 236 is disposed in a tooth shape and a toothed movable electrode group in which the second sensor movable electrode 246 is disposed in a tooth shape. Further, a plurality of the combinations may be provided. For example, in FIG. 13, the second physical quantity sensor portion 200 includes a detection unit including a combination of a second sensor fixed electrode 236A and a second sensor movable electrode 246A, and a detection unit including a combination of a second sensor fixed electrode 236B and a second sensor movable electrode 246B. In addition, the second sensor fixed electrode 236A extends from a second sensor fixed base portion 234A, and the second sensor fixed base portion 234A is fixed to the substrate 2 via the second sensor fixed electrode fixing portion 232A. Similarly, the second sensor fixed electrode 236B extends from a second sensor fixed base portion 234B, and the second sensor fixed base portion 234B is fixed to the substrate 2 via a second sensor fixed electrode fixing portion 232B.

Further, the second sensor fixed electrode fixing portion 232A and the second sensor fixed electrode fixing portion 232B may be disposed in the fixing portion disposition region AR described above. That is, in FIG. 13, the fixing portion 12, the first fixed electrode fixing portion 32-1A, the first fixed electrode fixing portion 32-1B, the second fixed electrode fixing portion 32-2, the second sensor fixed electrode fixing portion 232A, and the second sensor fixed electrode fixing portion 232B are concentratedly disposed in the fixing portion disposition region AR. The fixing portion disposition region AR is located between the movable body MB and the second sensor movable body MB. Thus, it is possible to reduce the influence of the warpage of the substrate 2 on the fixing portion 12, the first fixed electrode fixing portion 32-1A, the first fixed electrode fixing portion 32-1B, the second fixed electrode fixing portion 32-2, the second sensor fixed electrode fixing portion 232A, and the second sensor fixed electrode fixing portion 232B. From the above description, in the physical quantity sensor 1 of the present embodiment, the fixed electrode portion 30 includes the fixed base portion 34, the fixed electrode 36 extending from the fixed base portion 34, and the fixed electrode fixing portion 32 fixing the fixed base portion 34 to the substrate 2. The second physical quantity sensor portion 200 includes a second sensor fixed base portion 234, a second sensor fixed electrode 236 extending from the second sensor fixed base portion 234, and a second sensor fixed electrode fixing portion 232 fixing the second sensor fixed base portion 234 to the substrate 2. In addition, the fixing portion 12, the fixed electrode fixing portion 32, and the second sensor fixed electrode fixing portion 232 are disposed in the fixing portion disposition region AR. Thus, it is possible to reduce the influence of the warpage of the substrate 2 on the fixing portion 12, the fixed electrode fixing portion 32, and the second sensor fixed electrode fixing portion 232. The method regarding the second physical quantity sensor portion 200 illustrated in FIG. 13 may be appropriately combined with the configuration examples of FIGS. 1 and 8 to 11.

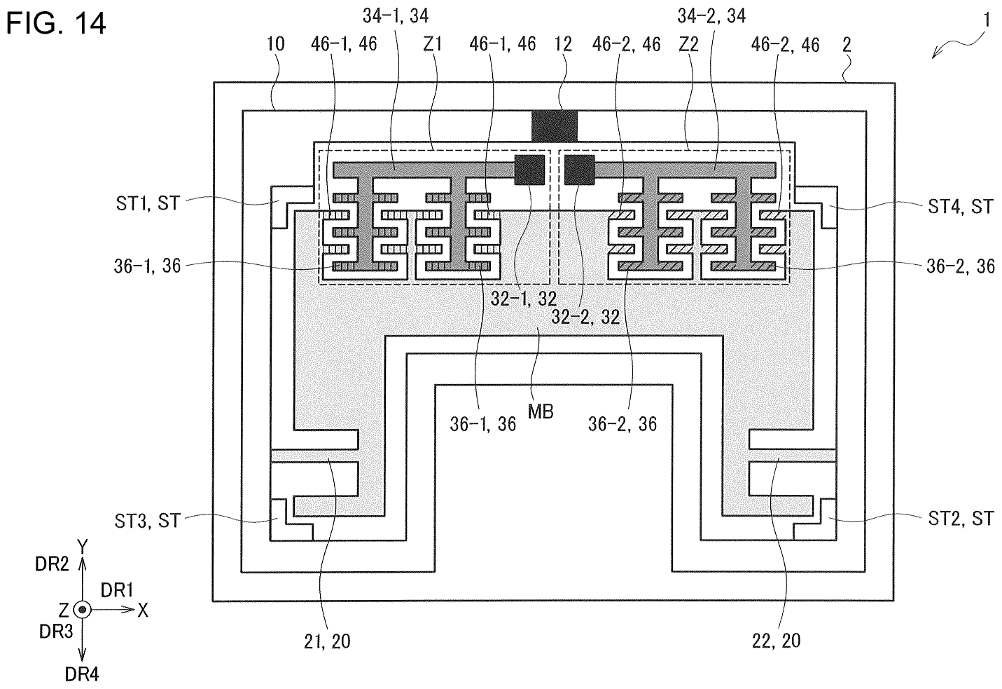

Further, the above is an example in which the fixed electrode 36 extends along the Y-axis with respect to the fixed base portion 34 and the movable electrode 46 extends along the Y-axis from the movable electrode portion 40, but the physical quantity sensor 1 according to the method of the present embodiment is not limited to these. For example, the physical quantity sensor 1 of the present embodiment may be configured as the configuration example illustrated in FIG. 14. In FIG. 14, the first fixed electrode 36-1 included in the first detection unit Z1 extends along the first direction DR1 with respect to the first fixed base portion 34-1, and the first movable electrode 46-1 extends from the first movable electrode portion 40-1 along the first direction DR1. Similarly, in FIG. 14, the second fixed electrode 36-2 included in the second detection unit Z2 extends along the first direction DR1 with respect to the second fixed base portion 34-2, and the second movable electrode 46-2 extends from the second movable electrode portion 40-2 along the first direction DR1. As described above, in the physical quantity sensor 1 of the present embodiment, the fixed electrode 36 extends from the fixed base portion 34 along the first direction DR1, and the movable electrode 46 extends from the movable electrode portion 40 along the first direction DR1. Thus, the damping effect of the squeeze film in the second direction DR2, which is caused by the fixed electrode 36 and the movable electrode 46, can be applied to the physical quantity sensor 1. Therefore, it is possible to improve vibration resistance and impact resistance of the physical quantity sensor 1.

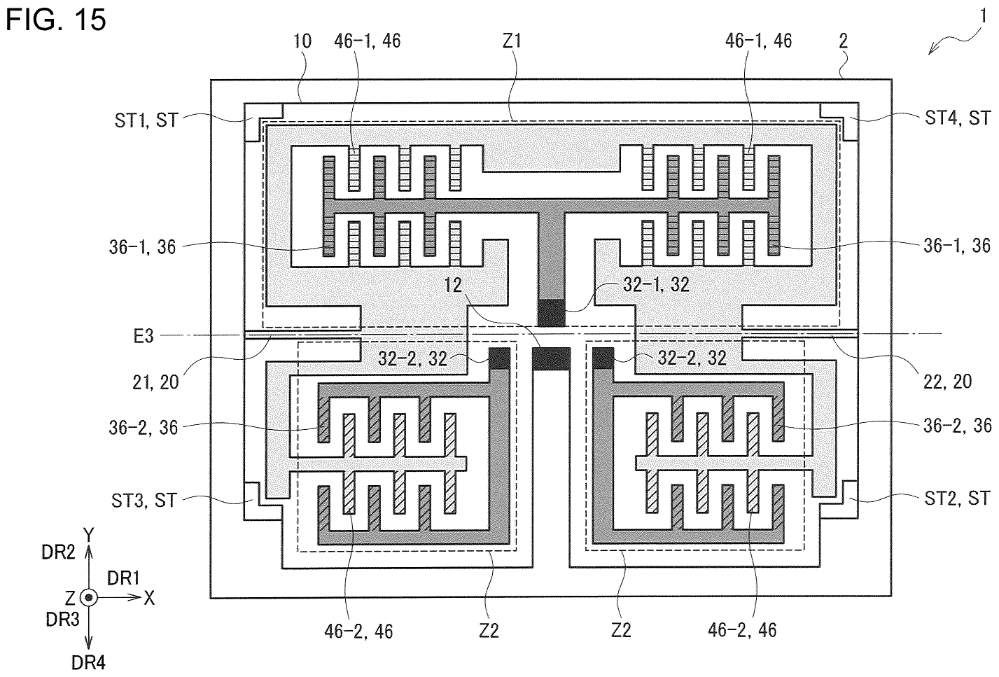

In addition, the above is an example in which the first detection unit Z1 and the second detection unit Z2 are disposed on the second direction DR2 side with respect to the support beam 20, which is a rotation axis. However, the physical quantity sensor 1 of the present embodiment is not limited thereto, and for example, as illustrated in FIG. 15, the first detection unit Z1 may be disposed on the second direction DR2 side with respect to the support beam 20, and the second detection unit Z2 may be disposed on the fourth direction DR4 side. In the configuration example of FIG. 15, the first support beam 21 and the second support beam 22 function as a rotation axis in a double-sided seesaw structure, as in the configuration example of FIG. 1. In addition, it is assumed that the rotational torque based on the first detection unit Z1 when a line indicated by E3 in FIG. 15 is used as the rotation axis is greater than the rotational torque based on the second detection unit Z2. For example, by reducing a volume of the movable body MB on the side where the second detection unit Z2 is disposed, the rotational torque based on the second detection unit Z2 when the line illustrated in E3 is used as the rotation axis can be reduced.

FIG. 16 illustrates a relationship between an operation of the second movable electrode 46-2 and the second fixed electrode 36-2 in the second detection unit Z2 according to the configuration example of FIG. 15. Since the relationship between the operation of the first movable electrode 46-1 and the first fixed electrode 36-1 in the first detection unit Z1 according to the configuration example of FIG. 15 is the same as a case described above in FIG. 3, the illustration and description thereof are omitted. As indicated by A20 and A21 of FIG. 16, in the initial state, positions of end portions of the second fixed electrode 36-2 and the second movable electrode 46-2 in the fifth direction DR5 match each other. In addition, a thickness of the second fixed electrode 36-2 in the third direction DR3 is smaller than a thickness of the second movable electrode 46-2 in the third direction DR3. Therefore, in the initial state, the position of the end portion of the second movable electrode 46-2 in the third direction DR3 is located on the third direction DR3 side with respect to the position of the end portion of the second fixed electrode 36-2 in the third direction DR3.

For example, when the first timing changes to the second timing, the second movable electrode 46-2 is displaced to the same direction as a direction of the acceleration generated in the physical quantity sensor 1, that is, to the third direction DR3 side, as indicated by A22 of FIG. 16, according to the relationship of the rotational torque. Similarly, for example, when the first timing changes to the third timing, the second movable electrode 46-2 is displaced to the fifth direction DR5 side as indicated by A23 of FIG. 16. When B21 and B22 of FIG. 16 are compared with each other, in a case where the acceleration in the third direction DR3 is applied from the initial state, an area where the second fixed electrode 36-2 and the second movable electrode 46-2 face each other is reduced. On the other hand, when B21 and B23 of FIG. 16 are compared with each other, in a case where the acceleration in the fifth direction DR5 is applied from the initial state, the area where the second fixed electrode 36-2 and the second movable electrode 46-2 face each other is maintained. That is, it can be seen that the second detection unit Z2 is similar to the second detection unit Z2 in the configuration example of FIG. 1 and the like in that when the acceleration in the third direction DR3 is generated, the second detection unit Z2 can detect a physical quantity in the third direction DR3 by detecting the change in the physical quantity due to the reduction in the area where the second fixed electrode 36-2 and the second movable electrode 46-2 face each other. As described above, even in the configuration example of FIG. 15, when the acceleration in the Z-axis direction is generated, the first detection unit Z1 and the second detection unit Z2 have a relationship in which one electrostatic capacitance changes and the other electrostatic capacitance does not change in both the +Z direction and the −Z direction.

As described above, the physical quantity sensor 1 having an asymmetric structure with respect to the rotation axis can be constructed by disposing the first detection unit Z1 on one side of the rotation axis and disposing the second detection unit Z2 on the other side of the rotation axis. As a result, sensitivity of the physical quantity sensor 1 can be enhanced. In addition, as compared with the configuration example of FIG. 1 and the like, the number of teeth of the fixed electrode 36 and the movable electrode 46 is increased, so that the damping effect of the squeeze film in the X-axis direction, which is caused by the fixed electrode 36 and the movable electrode 46, is further improved. Therefore, it is possible to further improve vibration resistance and impact resistance of the physical quantity sensor 1.

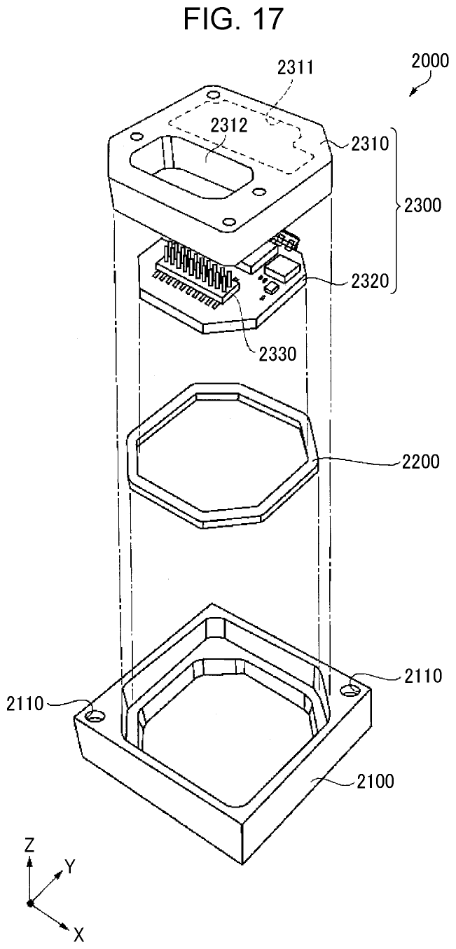

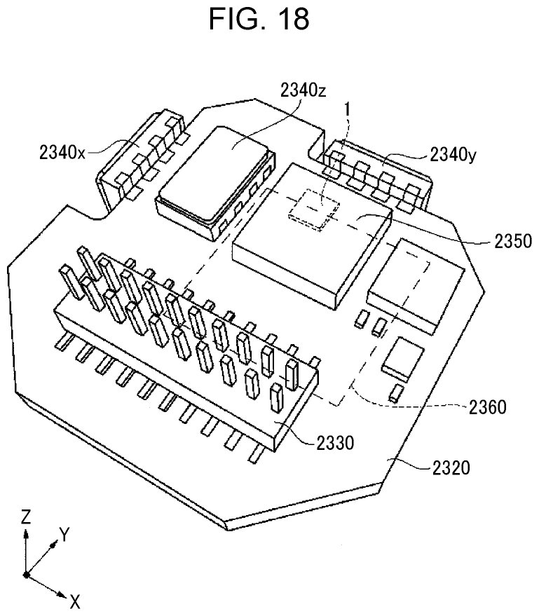

Further, the method of the present embodiment may be realized by, for example, an inertial measurement unit 2000 of FIGS. 17 and 18. That is, the inertial measurement unit 2000 of the present embodiment includes the physical quantity sensor 1 described above, and a control IC 2360 serving as a controller, which performs control based on a detection signal output from the physical quantity sensor 1. Thus, since the acceleration sensor unit 2350 including the physical quantity sensor 1 described above is used, it is possible to provide the inertial measurement unit 2000 which can obtain the effect of the physical quantity sensor 1 described above and realize high precision. The inertial measurement unit 2000 (inertial measurement unit (IMU)) is a device that detects inertial momentum of a moving object such as an automobile or a robot, such as a posture or a behavior. The inertial measurement unit 2000 is a so-called six-axis motion sensor including an acceleration sensor that detects accelerations ax, ay, and az in directions along the three axes and an angular velocity sensor that detects angular velocities ωx, ωy, and ωz around the three axes.

The inertial measurement unit 2000 is a rectangular parallelepiped having a substantially square planar shape. In addition, screw holes 2110 serving as mounting portions are formed in the vicinity of two vertexes located in a diagonal line direction of the square. The inertial measurement unit 2000 can be fixed to a mounting surface of a mounting target such as an automobile by allowing two screws to pass through the two screw holes 2110. A size of the inertial measurement unit 2000 can be reduced to a size that enables mounting in, for example, a smartphone or a digital camera by selecting components or changing a design thereof.

The inertial measurement unit 2000 includes an outer case 2100, a joining member 2200, and a sensor module 2300, and has a configuration in which the sensor module 2300 is inserted into the outer case 2100 with the joining member 2200 interposed therebetween. The sensor module 2300 includes an inner case 2310 and a circuit substrate 2320. The inner case 2310 is formed with a recessed portion 2311 for preventing contact with the circuit substrate 2320 or an opening 2312 for exposing a connector 2330 to be described later. The circuit substrate 2320 is joined to a lower surface of the inner case 2310 via an adhesive.

As illustrated in FIG. 18, the connector 2330, an angular velocity sensor 2340z that detects an angular velocity around the Z-axis, and an acceleration sensor unit 2350 that detects an acceleration in each axis direction of the X-axis, the Y-axis, and the Z-axis are mounted on an upper surface of the circuit substrate 2320. In addition, an angular velocity sensor 2340x that detects an angular velocity around the X-axis and an angular velocity sensor 2340y that detects an angular velocity around the Y-axis are mounted on a side surface of the circuit substrate 2320.

The acceleration sensor unit 2350 includes at least the physical quantity sensor 1 for measuring the acceleration in the Z-axis direction described above, and can detect the acceleration in the one-axis direction, the two-axis direction, or the three-axis direction as necessary. The angular velocity sensors 2340x, 2340y, and 2340z are not particularly limited, and for example, a vibration gyro sensor using a Coriolis force can be used.

Further, the control IC 2360 is mounted on the lower surface of the circuit substrate 2320. The control IC 2360 serving as the controller, which performs control based on the detection signal output from the physical quantity sensor 1, is, for example, a micro controller unit (MCU), includes a storage portion including a non-volatile memory, an A/D converter, and the like, and controls each portion of the inertial measurement unit 2000. A plurality of other electronic components are mounted on the circuit substrate 2320 in addition to the components.

The configuration of the inertial measurement unit 2000 is not limited to FIGS. 17 and 18. For example, the configuration may be adopted in which only the physical quantity sensor 1 is provided as an inertial sensor in the inertial measurement unit 2000 without providing the angular velocity sensors 2340x, 2340y, and 2340z. In this case, for example, the inertial measurement unit 2000 may be realized by accommodating the physical quantity sensor 1 and the control IC 2360 that realizes the controller in a package that is an accommodation container.

As described above, the present embodiment is related to a physical quantity sensor that detects a physical quantity in a third direction when three directions orthogonal to each other are set as a first direction, a second direction, and the third direction. The physical quantity sensor includes the fixing portion fixed to the substrate, the outer frame body coupled to the fixing portion, the support beam having one end coupled to the outer frame body and extending along the first direction, the movable body coupled to the other end of the support beam and disposed inside the outer frame body, and the fixed electrode portion provided on the substrate, disposed in the second direction of the support beam, and having the fixed electrode. The movable body includes the movable electrode portion having the movable electrode facing the fixed electrode, and the outer frame body has the stopper portion facing the movable body in an in-plane direction along the first direction and the second direction.

Thus, the movable body is integrated with the outer frame body having the stopper portion ST without being directly fixed to the substrate. Therefore, even when warpage or the like occurs in the substrate, the positional relationship between the stopper portion and the movable body can be prevented from changing. As a result, the stopper portion can be stably operated. As a result, the physical quantity sensor having excellent impact resistance and high reliability can be constructed.

Further, the outer frame body may include the first stopper portion provided at the first corner portion of the outer frame body, and the second stopper portion provided at the second corner portion of the outer frame body, as the stopper portion.

Thus, the stopper portion can be more stably operated.

Further, the outer frame body may include the third stopper portion provided at the third corner portion of the outer frame body facing the first corner portion, and the fourth stopper portion provided at the fourth corner portion of the outer frame body facing the second corner portion, as the stopper portion.

Thus, the stopper portion can be more stably operated.

Further, the outer frame body may surround the entire periphery of the movable body.

Thus, the degree of freedom in the disposition of the stopper portion ST can be increased.

Further, the outer frame body may be opened in at least a part of the region around the movable body.

Thus, the physical quantity sensor that stably operates the stopper portion can be constructed while improving the degree of freedom in design.

Further, the fixed electrode portion may include the fixed base portion, the fixed electrode extending from the fixed base portion, and the fixed electrode fixing portion fixing the fixed base portion to the substrate.

Thus, the tooth-shaped fixed electrode group can be stably configured.

Further, the fixing portion and the fixed electrode fixing portion may be disposed in the fixing portion disposition region.

Thus, the influence of warpage of the substrate on the fixing portion and the fixed electrode fixing portion can be reduced.

Further, the fixed electrode may extend from the fixed base portion along the first direction, and the movable electrode may extend from the movable electrode portion along the first direction.

Thus, the damping effect of the squeeze film in the second direction, which is caused by the fixed electrode and the movable electrode, can be applied to the physical quantity sensor.

Further, the fixed electrode portion may include the first fixed electrode portion having the first fixed electrode and the second fixed electrode portion having the second fixed electrode. In addition, the movable body may include the first movable electrode portion having the first movable electrode facing the first fixed electrode, and the second movable electrode portion having the second movable electrode facing the second fixed electrode. In addition, the first fixed electrode portion and the first movable electrode portion, and the second fixed electrode portion and the second movable electrode portion may be disposed along the second direction.

Thus, it is possible to construct the physical quantity sensor 1 having a one-sided seesaw structure which includes the first detection unit including the first fixed electrode portion and the first movable electrode portion, and the second detection unit 22 including the second fixed electrode portion and the second movable electrode portion.

Further, the thickness of the first movable electrode in the third direction may be smaller than the thickness of the first fixed electrode in the third direction, and the thickness of the second movable electrode in the third direction may be larger than the thickness of the second fixed electrode in the third direction.

Thus, the physical quantity applied in the third direction can be detected by the second detection unit including the second fixed electrode portion and the second movable electrode portion, and the physical quantity applied in the fifth direction opposite to the third direction can be detected by the first detection unit including the first fixed electrode portion and the first movable electrode portion.

Further, the outer frame body may include the first part along the first side and the second part along the second side facing the first side. In addition, the support beam may include the first support beam having one end coupled to the first part of the outer frame body and the other end coupled to the movable body, and the second support beam having one end coupled to the second part of the outer frame body and the other end coupled to the movable body.

Thus, the movable body coupled to the outer frame body can be more stably operated.

Further, the physical quantity sensor may include the second physical quantity sensor portion that is provided between the first support beam and the second support beam so as to detect the second physical quantity.

Thus, the area of the substrate can be effectively utilized. As a result, the size of the unit including the physical quantity sensor can be reduced.

Further, the second physical quantity sensor portion may include the second sensor movable body coupled to the outer frame body.

Thus, the outer frame body integrated with the second sensor movable body can be configured, thereby simplifying the manufacturing process.

Further, the fixed electrode portion may include the fixed base portion, the fixed electrode extending from the fixed base portion, and the fixed electrode fixing portion fixing the fixed base portion to the substrate. In addition, the second physical quantity sensor portion may include a second sensor fixed base portion, a second sensor fixed electrode extending from the second sensor fixed base portion, and a second sensor fixed electrode fixing portion fixing the second sensor fixed base portion to the substrate. In addition, the fixing portion, the fixed electrode fixing portion, and the second sensor fixed electrode fixing portion may be disposed in the fixing portion disposition region.

Thus, it is possible to reduce the influence of the warpage of the substrate on the fixing portion, the fixed electrode fixing portion, and the second sensor fixed electrode fixing portion.

Further, the outer frame body may include the first part along the first side, the second part along the second side facing the first side, and the third part intersecting the first part and the second part, and the fixing portion may be provided at the third part.

Thus, the outer frame body can be stably fixed to the substrate.

Further, the outer frame body may include the first part along the first side, the second part along the second side facing the first side, and the third part intersecting the first part and the second part. In addition, the fixing portion may be disposed in the region surrounded by the first part, the second part, and the third part.

Thus, the maximum distance from the fixing portion to the end portion of the outer frame body can be shortened. As a result, the occurrence of bending of the outer frame body can be suppressed, and thus a high-precision physical quantity sensor can be constructed.

Further, the inertial measurement unit of the present embodiment includes the physical quantity sensor described above, and the controller that performs control based on the detection signal output from the physical quantity sensor.

Although the present embodiment is described in detail as described above, those skilled in the art can easily understand that many modifications that do not substantially deviate from new matters and effects of the present disclosure are possible. Therefore, all such modification examples fall within the scope of the present disclosure. For example, in a specification or drawing, a term described at least once with a different term having a broader meaning or a synonym may be replaced with the different term in any part of the specification or the drawing. All combinations of the present embodiment and modification examples also fall within the scope of the present disclosure. Further, the configuration and the operation of the physical quantity sensor, the inertial measurement unit, and the like are not limited to those described in the present embodiment, and various modifications can be performed.

What is claimed is:

1. A physical quantity sensor, which detects a physical quantity in a Z-axis direction along a Z-axis when three axes orthogonal to each other are set as an X-axis, a Y-axis, and the Z-axis, comprising:
a fixing portion fixed to a substrate;
an outer frame body coupled to the fixing portion;
a support beam having one end coupled to the outer frame body and extending in an X-axis direction along the X-axis;
a fixed electrode portion fixed to the substrate, and including a fixed electrode that extends in a Y-axis direction along the Y-axis; and
a movable body including a movable electrode portion, coupled to another end of the support beam, and disposed inside the outer frame body, wherein
the movable electrode portion includes a movable electrode facing the fixed electrode in the X-axis direction, and
the outer frame body includes a stopper portion facing the movable body along a plane direction including the X-axis and the Y-axis.

2. The physical quantity sensor according to claim 1, wherein
the outer frame body includes
a first corner portion disposed on a minus side of the X-axis,
a second corner portion disposed on a plus side of the X-axis,
a third corner portion disposed on the minus side of the X-axis, and disposed on a minus side of the Y-axis with respect to the first corner portion, and
a fourth corner portion disposed on the plus side of the X-axis, and disposed on a plus side of the Y-axis with respect to the second corner portion, and
the stopper portion includes
a first stopper portion provided at the first corner portion of the outer frame body, and
a second stopper portion provided at the second corner portion of the outer frame body.

3. The physical quantity sensor according to claim 2, wherein
the stopper portion includes
a third stopper portion provided at the third corner portion of the outer frame body, and
a fourth stopper portion provided at the fourth corner portion of the outer frame body.

4. The physical quantity sensor according to claim 1, wherein
the outer frame body surrounds the movable body in a plan view from the Z-axis direction.

5. The physical quantity sensor according to claim 1, wherein
the outer frame body does not surround at least a part of a region around the movable body in a plan view from the Z-axis direction.

6. The physical quantity sensor according to claim 1, wherein
the fixed electrode portion includes
a fixed base portion, and
a fixed electrode fixing portion fixing the fixed base portion to the substrate, and
the fixed electrode extends from the fixed base portion.

7. The physical quantity sensor according to claim 6, wherein
the fixing portion and the fixed electrode fixing portion are disposed in a vicinity of a center of the substrate in a plan view from the Z-axis direction.

8. The physical quantity sensor according to claim 1, wherein
the fixed electrode portion includes
a first fixed electrode portion having a first fixed electrode, and
a second fixed electrode portion having a second fixed electrode, and
the movable body includes
a first movable electrode portion including a first movable electrode that faces the first fixed electrode in the X-axis direction, and
a second movable electrode portion including a second movable electrode that faces the second fixed electrode in the X-axis direction.

9. The physical quantity sensor according to claim 8, wherein
a thickness of the first movable electrode along the Z-axis is larger than a thickness of the first fixed electrode in the Z-axis direction, and
a thickness of the second movable electrode along the Z-axis is smaller than a thickness of the second fixed electrode in the Z-axis direction.

10. The physical quantity sensor according to claim 1, wherein
the outer frame body includes
a first part disposed on a minus side of the X-axis, and extending along the Y-axis direction, and
a second part disposed on a plus side of the X-axis, extending along the Y-axis direction, and facing the first part in the X-axis direction, and
the support beam includes
a first support beam having one end coupled to the first part and another end coupled to the movable body, and
a second support beam having one end coupled to the second part and another end coupled to the movable body.

11. The physical quantity sensor according to claim 10, further comprising:
a physical quantity sensor portion disposed between the first support beam and the second support beam in a plan view from the Z-axis direction, and detecting a physical quantity in the plane direction.

12. The physical quantity sensor according to claim 11, wherein
the physical quantity sensor portion includes a second movable body, and
the second movable body is coupled to the outer frame body.

13. The physical quantity sensor according to claim 12, wherein
the fixed electrode portion includes
a fixed base portion; and
a fixed electrode fixing portion fixing the fixed base portion to the substrate,
the fixed electrode extends from the fixed base portion,
the physical quantity sensor portion includes
a second fixed base portion, and
a second fixed electrode fixing portion fixing the second fixed base portion to the substrate,
the second fixed electrode extends from the second fixed base portion, and
the fixing portion, the fixed electrode fixing portion, and the second fixed electrode fixing portion are disposed in a vicinity of a center of the substrate in the plan view from the Z-axis direction.

14. The physical quantity sensor according to claim 1, wherein
the outer frame body includes
a first part disposed on a minus side of the X-axis, and extending along the Y-axis direction,
a second part disposed on a plus side of the X-axis, extending along the Y-axis direction, and facing the first part in the X-axis direction, and
a third part extending along the X-axis direction, and
the fixing portion is provided at the third part.

15. The physical quantity sensor according to claim 14, wherein
the fixing portion is surrounded by the first part, the second part, and the third part in a plan view from the Z-axis direction.

16. An inertial measurement unit comprising:
the physical quantity sensor according to claim 1; and
a controller that performs control based on a detection signal output from the physical quantity sensor.
